(19) United States
(12) Patent Application Publication
(10) Pub. No.: US 2026/0187470 A1
(43) Pub. Date: Jul. 2, 2026

(54) TRAINING AGENTS THROUGH REINFORCED LEARNING TO IMPROVE DECISION OR DATA TRAVEL PATHS

(71) Applicant: American Express Travel Related Services Company, Inc., New York, NY (US)

(72) Inventors: Dagen WANG, Houston, TX (US); Andras L. FERENCZI, Scottsdale, AZ (US); Alaric M. EBY, Scottsdale, AZ (US)

(73) Assignee: American Express Travel Related Services Company, Inc., New York, NY (US)

(21) Appl. No.: 19/007,153

(22) Filed: Dec. 31, 2024

(51) Int. Cl. G06N 3/092

(52) U.S. Cl. CPC G06N 3/092

(57) ABSTRACT

System, method, and computer program product embodiments control routing within an agentic ecosystem using agentic reinforcement learning. A first computer processor receives log entries of agentic activity from an agent activity log data store writable by a second computer processor associated with at least one of a number of AI agents of an agentic ecosystem. The first computer processor generates agent transition probabilities based on the received log entries. The agent transition probabilities influence probabilistic routing decisions of AI agents of the agentic ecosystem. The first computer processor transmits the agent transition probabilities to a plurality of the AI agents of the agentic ecosystem. These steps can be repeated iteratively to improve learning.

### BACKGROUND

### Field

This application generally relates to monitoring and control of artificial-intelligence (AI) agentic systems for performing tasks, and in particular to training agents through reinforced learning to improve data travel paths.

### Related Art

Systems for performing tasks may use a monolithic architecture, in which one software application running on one hardware system performs all aspects of a user-requested task, or may call on one or more services (e.g., one or more microservices) to perform the task. The one or more services may reside on computer systems (e.g., different servers or within a cloud-based hardware) different from a user device from which one or more of them is called and/or from each other. The user device and different computer systems hosting the one or more services can be connected via a network (e.g., the internet) on a hardware level and, on a software level, by one or more application programming interfaces (APIs), each of which can serve as contract of communication between two software components, defining expected inputs and return outputs.

Recent developments in machine-learning architectures, including the development of generative AI, such as large language models (LLMs) and systems that can comprehend and/or generate audio, video, or multi-model content in near real time, have led to the creation of autonomous AI agents that may more completely, more flexibly, and more robustly comprehend queries and problems than was previously possible using monolithic or service-based architectures, for example, by automatically resolving ambiguities in sensible ways and breaking down tasks into subtasks that can be addressed in architectures of multiple AI agents working together.

### BRIEF SUMMARY

Disclosed herein are system, apparatus, device, method and/or computer program product embodiments, and/or combinations and sub-combinations thereof, for training agents through reinforced learning to improve agentic choices of data travel paths (routing) or other decision-making. Computer-implemented methods, systems, and non-transitory computer-readable devices as described herein can provide speed, efficiency, and security advantages to computer systems and networks of computer systems. These advantages can be accomplished, for example, by reducing processor cycles and/or memory usage, by conserving network bandwidth, e.g., by refraining from performing suboptimal or non-useful agentic routing, and/or by eliminating or limiting improper dissemination of sensitive user data. The advantages can be accomplished, for example, by de-preferencing or prohibiting the routing of such data to malicious or compromised agents or agents operated by hostile providers or operating in hostile networks or markets. System, method, and computer program product embodiments as described herein can be employed to address problems associated with agentic task performance by analyzing agentic architecture log data and providing agents with reinforced-learning routing information so as to proactively preference, de-preference, or prohibit certain agentic interactions, and/or retroactively analyze agentic interactions, thus reducing costs associated with cyberfraud, data theft, and unwanted private data dissemination. System, method, and computer program product embodiments as described herein thus permit human users to enlist agentic systems to perform tasks with greater confidence and convenience.

In an aspect, an example computer-implemented method of routing within an agentic ecosystem uses agentic reinforcement learning. A first computer processor receives log entries of agentic activity from an agent activity log data store writable by a second computer processor associated with at least one of a number of AI agents of an agentic ecosystem. The first computer processor generates agent transition probabilities based on the received log entries. The agent transition probabilities influence probabilistic routing decisions of AI agents of the agentic ecosystem. The first computer processor transmits the agent transition probabilities to a plurality of the AI agents of the agentic ecosystem. These steps can be repeated iteratively to improve learning. In some examples, after receiving the agent transition probabilities from the first computer processor, the second computer processor can select an AI agent of an agentic ecosystem based on the received agent transition probabilities, transmit a request message to the selected AI agent; and, log the selection of the AI agent to the agent activity log data store, the agent activity log data store being readable by the first computer processor. In some examples, the first computer processor can also receive user feedback about the outcome of a user-initiated task or transaction processed by an agentic task architecture of the agentic ecosystem. The agentic task architecture includes AI agents of the agentic ecosystem communicatively coupled to process the user-initiated task or transaction. The first computer processor can generate the agent transition probabilities based on the on the received log entries and the user feedback.

System, device, and non-transitory computer-readable medium aspects are also disclosed. Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### BRIEF DESCRIPTION OF THE DRAWINGS

The accompanying drawings are incorporated herein and form a part of the specification.

FIG. 1 is a block diagram illustrating an example service-based architecture for accomplishing tasks.

FIG. 2 is a block diagram illustrating an example agentic architecture for accomplishing tasks.

FIG. 3 is a network diagram illustrating potential agentic routes within an agentic ecosystem.

FIG. 4A is a block diagram of an example agentic reinforcement learning system implementing a centralized reward model.

FIG. 4B is a block diagram of an example agentic reinforcement learning system implementing a distributed local reward model.

FIG. 5 is a flow diagram illustrating example functioning of an agentic reinforcement learning system.

FIG. 6 is a diagram of an example directed acyclic graph modeling action choices (e.g. routing choices) of a reinforcement-learning-trained agent.

FIG. 7 is a flow diagram illustrating an example method of agentic routing using agentic reinforcement learning, using a centralized reward model, from the perspective of a calling agent.

FIG. 8 is a flow diagram illustrating an example method of agentic routing using agentic reinforcement learning, using a centralized reward model, from the perspective of an agentic decision training system.

FIG. 9 is a flow diagram illustrating an example method of agentic routing using agentic reinforcement learning, using a distributed local reward model, from the perspective of a calling agent.

FIG. 10 is a block diagram illustrating an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof for agentic architecture request routing by training of AI agents through reinforced learning to improve data travel paths. An agentic architecture includes a plurality of automated AI agents employed to accomplish a task or sub-tasks of a request. An initial request to perform a task can be made by a human user or an AI system. The task can be to answer a question, to perform a purchase transaction or financial transaction (e.g., making a payment by transferring money or digital property such as cryptocurrency, moving money between accounts, invoicing or billing payments or sending reminders for payments due, purchasing or selling securities or other financial instruments), to perform research or information retrieval, to draft or modify (e.g., edit, copyedit, or revise) a document, to generate or modify video, audio, or multimodal content, to develop and/or test software or a software tool (e.g., perform code generation), to diagnose a medical or computer issue or identify one or more software bugs, to set a reminder, to schedule a meeting or appointment, to acquire and/or playback a media content item, to analyze data, to handle customer support or sales support queries, to automate repetitive processes (e.g., data entry, file conversion, or document routing), to assist in prototyping or design tasks, to perform monitoring or diagnostics of systems, to perform predictive maintenance, to develop or devise strategy or planning, to detect fraud, misinformation, or deepfakes, to perform educative or skill training tasks, to perform supply chain optimization, route planning or resource allocation, to perform threat analysis or surveillance, or to model complicated systems (e.g., global climate, physiological, or pharmacokinetic systems), as but a few examples.

Accordingly, an initial request to an AI agent that may result in the construction of an agentic architecture to carry it out may be, as examples, “buy me a coffee mug I'll like,” “plan and book a dream vacation for myself and my spouse,” “fix the refrigerator,” “schedule my car maintenance,” “put half the money in my savings account to more profitable use,” “sell my car before the next registration renewal,” “check whether all my bills have been paid for this month,” “figure out if there's a better cell phone service plan that I can sign up for at lower cost,” “summarize this” (piece of media), or “play this game for me until” (a certain goal is reached). Agents within an agentic architecture may be granted access to private data that may place any of these various requests in context, e.g., by understanding available assets and/or preferences of the requesting human user.

As one example, an agentic architecture may be granted access to the user's streaming content service watchlist or viewing history to determine that the user enjoys a certain movie series, and may order a coffee mug related to the movie series. As another example, an agentic architecture may search records, such as social media account information, to determine the spouse of a user, to understand the spouse's preferences and the financial resources of the user and spouse, and thus to choose an appropriate vacation destination with an affordable itinerary. As another example, an agentic architecture may have access to, or configure itself to obtain, knowledge of the make, model, year, and condition of the user's vehicle, and may access information to ascertain the market value of the vehicle in order to solicit offers or bids for the vehicle (e.g., from other agentic architectures operating on behalf of other users) and sell the vehicle at a fair price. Agents within an agentic architecture may be granted access to control of resources or assets, including private computing resources (e.g., to control of the user's computer or mobile device) and/or of financial resources (e.g., to control of the user's investment accounts, bank accounts, credit accounts, bill accounts, or other financial assets), in order to perform requested tasks. In some examples, an agentic system may develop a plan for accomplishing a requested task and seek confirmation from the requesting user before executing the plan. In some examples, one or more agents of an agentic architecture may control one or more robots to perform tasks in the physical world.

At least some of the AI agents within the agentic architecture can be configured (e.g., trained) to decompose assigned tasks into subtasks and to strategically or organically assemble respective subsidiary agentic architectures on-the-fly in furtherance of a principal task prompted by the initial request. Various agents within the agentic architecture can carry out individual subtasks, or sub-subtasks, etc., of the principal task. As used herein, “subtask” refers to any task performed in furtherance of the principal task, at any level of task subdivision.

The principal task or any subtask can be perform-once, recurring at defined time intervals or other triggers, or continuous (e.g., the principal task may be repetitive or ongoing such that it is not completable but may nevertheless result in useful subtask completions). An agentic architecture formed in response to an initial request can be a fluid structure, being wholly or partially assembled, disassembled, reassembled, or modified at various times in the carrying out of the principal task. One or more agents within the agentic architecture may interact with the user or other agents within the architecture to clarify information or task parameters, and/or to obtain needed authorizations, during the carrying out of the principal task, and sub-portions of the agentic architecture may be modified or reformed based on such clarification. Because each of a plurality of AI agents within an agentic architecture may develop its own agentic architecture to perform subtasks it deems necessary to completing its assigned task, the agentic architecture may take the form of a network or tree, with potentially hundreds, thousands, or millions of AI agent instances initialized, provisioned, and autonomously operated. An agentic architecture may thereby perform actions on behalf of the requesting human or AI user.

One or more agents within an agentic task architecture may interact with one or more other agents within the agentic architecture, with an original requesting user (e.g., via a chatbot user interface displayed by a user computer system or device, email, text message, telephone, etc.), or with other human agents (e.g., via a chatbot user interface displayed by a human agent computer system or device, email, text message, telephone, etc.), e.g., to obtain clarifying information, to request and be granted necessary authorizations or permissions, to explain the necessity of the authorizations or permissions so as to satisfy user doubts as to the necessity of the authorizations or permissions, to receive instructions and to make confirming assurances pertinent to the safe use of resources, and/or to obtain expert help (either from other AI agents or from humans). As examples, an AI agent may be configured (e.g., trained) to request a needed account password, to search for a query using an internet search engine, to post a request for a problem's solution to a public or private message board or chat room where it may be responded to by humans or other AI agents, or to email or call a human agent to obtain information or provide instructions. AI agents may form contracts with other AI agents or human agents according to which services may be rendered and compensated. For example, a price of performing a principal task may be distributed to agents throughout an agentic architecture, e.g., according to established budgets. Agents may be configured to perform honesty and sanity self-checks or counter-checks to ensure that they themselves and other AI agents that they interact with comply with made assurances, fulfill made promises, and otherwise behave responsibly and ethically. Computer systems that host agents that do not perform securely and according to established standards and contracts may be denied access to resources, denied payment for agent services, denied future agent work, or held accountable by other methods.

In these contexts, monitoring and control of agentic architectures, and ensuring that agentic architectures operate efficiently, securely, fairly, loyally, responsibly, and accountably, can pose technical challenges. The actions of misbehaving or disused agents may need to be paused, terminated or, if possible, unwound (e.g., to place assets or resources back into positions before the actions of agents). Misapprehensions of active agents may need to be corrected in order to place the active agents' goals and operations back into conformance with, and in furtherance of, the principal task or a subtask. So-called “zombie” AI agents that remain active after a parent task has been satisfactorily completed or canceled may need to be tracked and terminated. The authorizations of agents may need to be limited when the agents exceed the intended scope of the permissions granted them, or expanded when the agents have insufficient resources to complete their necessary and proper tasks. The security of the agents may need to be inquired upon or rectified to ensure that agents do not improperly leak sensitive information and are not hijacked for improper purposes by malicious actors. Malicious agents or agents hijacked by malicious actors may need to be detected and avoided. At root of many of these challenges, the existence and activities of autonomous AI agents should be trackable in ways that are secure and certain. Some of these challenges are addressed in the present application, as described below.

### Service-Based Task Architectures and Agentic Task Architectures

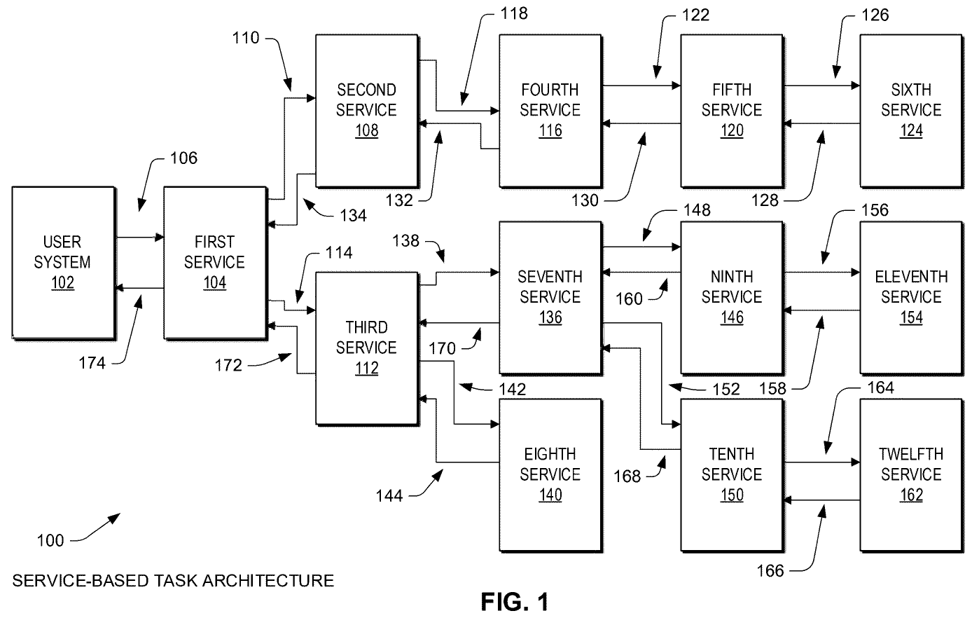

FIG. 1 illustrates an example architecture 100 for carrying out a task by services. The services in architecture 100 are not themselves autonomous AI agents and therefore have more limited capabilities than those that would be had by AI agents, as described in greater detail below. A user system 102 can be configured to accept an initial user request as a user input to the user system 102. In some examples, the user request can be formed by the user as a command in accordance with a defined syntax for the command, whereas in other examples, the user request can be in the form of a natural-language utterance. The user input can be textual (e.g., by physical or virtual keyboard), speech-based (e.g., via a microphone, and/or by inputting an audio file), visual (e.g., via a camera, and/or by inputting a still image or video file), or multimodal, as examples. The request can include data to process or to be used as context information, such as one or more documents, media files, spreadsheets, or databases. The user system 102 can transmit the initial user request, or a data signal derived therefrom, to a first service 104, via link 106. Link 106 can comprise hardware aspects (e.g., physical network connections between the user system 102 and the first service 104), software aspects (e.g., API structure defining the forms of inputs to the first service 104), or both. The first service 104 may be configured to parse and/or process the initial user request and thereby to make one or more determinations about actions to take to satisfy the initial request. For example, the first service 104 may comprehend a limited list of other services that may be employable and appropriate to service the initial request.

The first service 104 may, for example, call on second service 108 via link 110, and third service 112 via link 114. Link 110 may include, for example, an API to second service 108, and, similarly, link 114 may include, for example, an API to third service 112. Second service 108 may be configured to call on one or more other services, such as fourth service 116 via link 118, which may include an API to fourth service 116. Fourth service 116 may, similarly, be configured to place API calls to one or more other services, such as to fifth service 120 via link 122, and fifth service 120 may be configured to place an API call to sixth service 124 via link 126. Sixth service 124 acts as a sub-service to fifth service 120, which in turn acts as a sub-service to fourth service 116, and so on, each called service performing a well-defined subtask and providing well-defined outputs based on well-formed inputs provided over links 126, 122, and 118, respectively.

When the sixth service 124 has completed its processing subtask, the output of the sixth service 124 may be transmitted, in the illustrated example architecture 100, back to the calling fifth service 120 via link 128. Having received the output of the sixth service 124, the fifth service 120 may complete its subtask and provide its output via link 130 back to fourth service 116. Fourth service 116 may make use of the received output of fifth service 120 to complete its subtask and report its own output back to second service 108 via link 132. Second service 108 may subsequently make use of the received output of fourth service 116 to complete its subtask and report its output back to first service 104 via link 134.

Subsequently or meanwhile, first service 104 may have called third service 112. For example, first service 104 may call third service 112 in parallel with the call to second service 108 if the input to third service 112, provided via link 114, does not depend on the output from second service 108 provided via link 134. On the other hand, first service 104 may wait for the output of second service 108 to be provided, via link 134, before calling third service 112 if the input to third service 112 provided via link 114 requires the inclusion of information that is provided by or based on the output of second service 108. Third service 112 may then call seventh service 136 via link 138 and eighth service 140 via link 142. Eighth service 140 may perform its function and return its output to third service 112 via link 144. Seventh service 136 may call ninth service 146 via link 148 and tenth service 150 via link 152. Ninth service 146 may call eleventh service 154 via link 156 and receive the output therefrom via link 158. Ninth service 146 may then complete its function and return its output to seventh service 136 via link 160. Tenth service 150 may call twelfth service 162 via link 164 and receive the output therefrom via link 166. Tenth service 150 may then complete its function and return its output to seventh service 136 via link 168. Ninth service 146 and tenth service 150 may operate contemporaneously in parallel, based on the input of one not depending on the output of the other, or in sequence based on the input of one depending on the output of the other.

Having received responses from both ninth service 146 and tenth service 150, seventh service 136 may complete its function and return its output to third service 112 via link 170. Seventh service 136 and eighth service 140 may operate contemporaneously in parallel, based on the input of one not depending on the output of the other, or in sequence based on the input of one depending on the output of the other. Having received responses from both seventh service 136 and eighth service 140, third service 116 may complete its function and return its output to first service 112 via link 172. Having received responses from both second service 108 and third service 112, first service 104 may complete a response to the user request and return the response to the user system 102 via link 174.

If any of the services in the service-based task architecture 100 is not able to complete its function, it may return an error message, rather than the expected output, via the respective return link. Based on the outputs of each service in the architecture 100 being necessary for formulating the response to the initial user request, an error at any service in the architecture 100 may prevent the expected response to the user request, and instead result, ultimately, in an error message being provided via return link 174. An error may result from malfunctioning of a service (e.g., a software bug in the service or the service being down), or incomplete, inappropriate, malformed, or incorrect inputs being provided to the service, as examples. Because the underlying architecture 100 may be opaque to the user (e.g., from the perspective of user system 102), it may not be clear to the end user or user system 102, solely from the error message ultimately received via link 174, which service or services in the architecture 100 was or were not able to successfully perform its task or their respective tasks. Debugging a user request at runtime may thus be difficult or impossible for the end user after the architecture 100 and its component services are placed into production.

Moreover, the individual services in architecture 100, lacking the cognitive abilities of AI agents, are not capable of interacting with their respective calling services to complete, clarify, or contextualize inputs that may be missing, incorrect, or ambiguous. The individual services thus are not capable of resolving errors, either reactively or proactively, in an automated fashion. Additionally, each service in architecture 100 may be capable only of calling services of which it is made aware programmatically at development time, or from a database that must be manually curated, because the services are not individually capable of searching for or otherwise discovering and procuring for use services that are not expressly provided for at development time. For these reasons, substantial development and testing burden is placed on the developers of the architecture 100 or on individual services within the architecture 100.

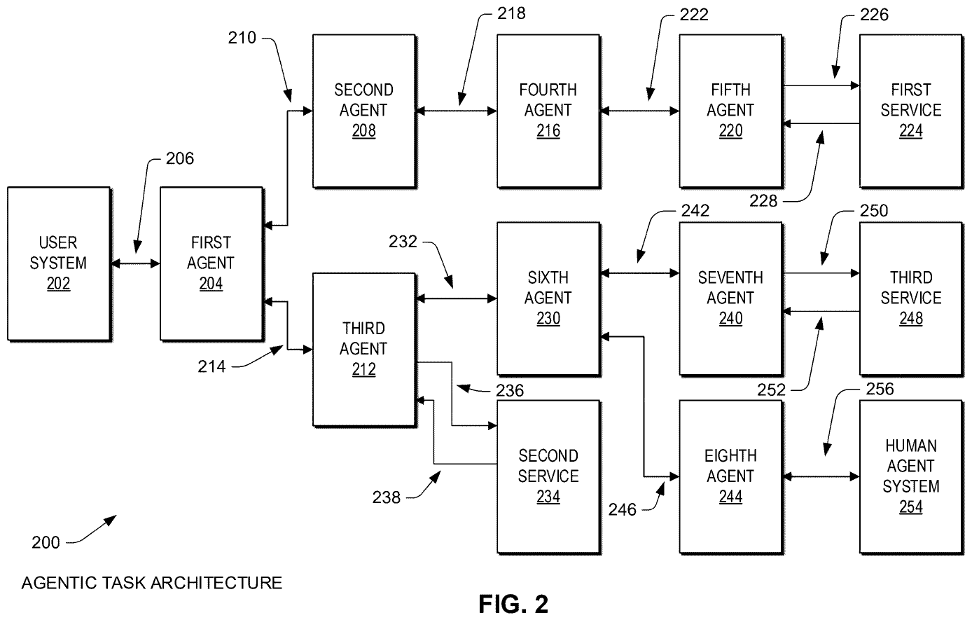

FIG. 2 illustrates an example agentic task architecture 200 comprising a number of agents. Except where stated otherwise, the agents are intelligent autonomous AI systems, having cognitive capabilities that derive from the structures and training of underlying deep-learning models, rather than having their logic hard-coded, as in the case of the services shown in FIG. 1. Although the example agentic task architecture 200 has a graph structure that resembles the graph structure of service-based task architecture 100, agentic task architecture 200 has a number of important differences from, and advantages over, service-based task architecture 100. An agentic task architecture, such as agentic task architecture 200, may be formed from an agentic ecosystem (e.g., an LLM ecosystem) that includes various agents that may be selected from among agents in the agentic ecosystem to form the agentic task architecture. The agentic ecosystem may evolve over time to include new agents and to remove disused, obsoleted, or deprecated agents. Agents in the agentic ecosystem may grow and shed capabilities and access to resources over time. Agents may communicate with each other via a number of methods, modalities, and protocols, including internet-based protocols, such as Hypertext Transfer Protocol (HTTP), and telephony-based protocols. As an example of the latter, AI agents may communicate with each other using speech, in English or another language, over a telephone connection. Agents may use different APIs to call one another or to call different services.

An AI agent may comprise, for example, a machine-learning model (e.g., an LLM) coupled to hard-coded logic to provide cognitive capabilities. Different AI agents may be coupled to each other by communication connections, e.g., over the internet, to transmit requests and replies to each other. The cognitive intelligence of an AI agent distinguishes it from the hard-coded procedural functioning of a conventional service, such as the services that make up the service-based task architecture 100 in FIG. 1. An AI agent may use machine-learning capabilities to consider problems and formulate solutions; to decompose larger, more difficult tasks into smaller, easier-to-achieve subtasks; and to independently understand, note, and proactively or reactively resolve ambiguities, errors, or gaps in provided inputs. In some examples, an AI agent may access context-providing data resources, e.g., via the internet, a directory, or a data store to resolve ambiguities, errors, or gaps in provided inputs. In some examples, an AI agent may interactively converse with other AI agents or human agents, such as a calling user, to resolve ambiguities, errors, or gaps in provided inputs. Whereas a service-based task architecture may fail due to accomplish a task due to an input error in the initial user request or due to an error in an intermediate service output developed somewhere along a path in the service-based task architecture, agents in an agentic task architecture may autonomously and/or interactively resolve such an error and accomplish the task, for example, without requiring additional user input to manually resolve the error.

A user system 202 may accept an initial request from a human user as input. The request can take any of the forms described above with regard to the user request in the service-based task architecture 100. The request, or a data signal derived therefrom, can be transmitted to a first agent 204 via connection 206. The first agent 204 can include a deep machine-learning system configured to process the request to determine a task from the request (e.g., “purchase shoes”) and one or more subtasks needed to fulfill the request (e.g., “access a plurality of online shoe stores and compare prices to find the best price among shoes matching the size and style preferences of the user”). As part of this process, the first agent 204 may determine that additional information is needed to complete, contextualize, or disambiguate elements of the request.

The first agent 204 may be configured to interactively converse with the user system 202 (e.g., with the user operating the user system 202, or with information resources or computational resources available to the user system 202) to complete, contextualize, or disambiguate elements of the request. For example, the first agent 204 may determine that the request involves the purchase of new shoes for the user, but the request does not include a shoe size or style preference. First agent 204 may send a textual reply to user system 202 via connection 206 asking for a shoe size and/or style preference. A user reply input to the user system 202 and sent to the first agent 204 via connection 206 will then be considered, cumulatively to the initial user request, in determining one or more subtasks needed to fulfill the request. Additionally or alternatively, first agent 204 may access resources that the first agent 204 is authorized to access, such as one or more purchase histories of the user, to confidently infer missing, incomplete, or ambiguous request-related information, automatedly filling information gaps in the initial user request or in subsequent communications from the user.

The first agent 204 may then carry out the determined subtasks itself, or enlist one or more other agents to fulfill subtasks that the first agent 204 is not competent or not authorized to carry out, or that the other agents may fulfill with some advantage over the first agent 204, e.g., greater efficiency, greater speed, lower cost, less environmental impact, or better accuracy. In the illustrated example, the first agent finds and enlists second agent 208, sending a subtask request to second agent 208 via connection 210, and finds and enlists third agent 212, sending another subtask request (or the same subtask request) to third agent 212 via connection 214.

In some examples, first agent 204 may assign the same subtask request to multiple other agents, effectively engaging the multiple other agents in competition with each other to perform the subtask with the greatest efficiency, the greatest accuracy, the greatest speed, or in accordance with some other metric. For example, the first agent 204 may contract with multiple other agents with the understanding that only the first agent to return a satisfactory completion of the awarded tasks receives compensation for the task.

In some examples, first agent 204 may award subtasks by auction to one or more competing other agents, which may bid against each other for task work. In yet other examples, the first agent 204 may award a subtask to an agent of primary preference but then re-award the task to a different agent of secondary preference after a the agent of primary preference fails to complete the awarded task, or fails to complete it within a certain time. In still other examples, other criteria, such as trust metrics, may dictate how the first agent 204 selects other agents to perform subtasks.

In yet other examples, there may be only one option for choice of agent to perform a subtask, as where only one agent controls or guards some particular resource, such as access to a particular proprietary payment network or data store. As one example, if an agent determines to purchase a particular transit fare (e.g., airfare) as part of a travel booking, the agent may be compelled to use another agent that is owned or controlled by the carrier (e.g., airline) associated with the travel booking. As another example, if an agent determines to use a particular payment card (e.g., credit or debit card) of the user to pay for a good or service, the agent may be compelled to use another agent that is owned or controlled by the payment card issuer to carry out the payment transaction.

In the agentic task architecture 200, the first agent 204 need not be initially aware (e.g., programmatically aware) of the existence of the agents to which it awards subtasks (e.g., agents 208, 212, in the illustrated example). In some examples, the first agent 204 may perform a search for appropriate agents, or make public or private inquiries as to suitable agents matching a given subtask. This may be in contrast to the architecture 100 of FIG. 1, in which each service may need to be programmed, at development time, with the identities of services to call for various subtasks, or to access a database with such identities, which database must then be curated, maintained, and updated. This advantage of the agentic architecture 200 permits for the continual or sporadic emergence of new agents without requiring developer effort to make older agents expressly aware of the new agents.

Second agent 208 may determine that its assigned subtask involves one or more subtasks that may require or advantageously employ another agent to carry out. Accordingly, in the illustrated example, second agent 208 may find and enlist fourth agent 216 and transmit one or more subtask requests to fourth agent 216 via connection 218. Similarly, fourth agent 216 may transmit one or more subtask requests to fifth agent 220 via connection 222. Fifth agent 220 may determine that a conventional service may be accessed to perform a subtask in order to complete the subtask assigned to fifth agent 220 from fourth agent 216, such as a data retrieval or processing task, a transaction task, or a payment task, and accordingly, fifth agent 220 may place an API call to first service 224 via link 226, and receive a response from first service 224 via link 228. Fifth agent 220 may transmit a reply to fourth agent 216 via connection 222, fourth agent 216 may transmit a reply to second agent 208 via connection 218, and second agent 208 may transmit a reply to first agent 204 via connection 210.

First, second, fourth, and fifth agents 204, 208, 216, and 220 may also carry out interactive dialogues with each other via their respective connections 210, 218, and 222, e.g., to complete or clarify inputs, reactively or proactively resolve errors, and provide useful feedback data, as described above with regard to the relationship between first agent 204 and user system 202. Requests may be carried up the chain of agentic command, and replies may be transferred back down the chain of agentic command. Accordingly, even if the structure of the agentic task architecture 200 is opaque from the perspective of the user system 202, the architecture 200 is more robust as against failures or errors. As one example, an error generated somewhere within the architecture 200, such as at an endpoint of the architecture graph (e.g., a first service 224), need not propagate all the way back to user system 202 and cause the failure of the initially requested task, if it can be resolved at some intermediate point in the architecture 200. For example, if first service 224 returns an error to fifth agent 220, fifth agent 220 can automatedly revise its API call to first service 224, e.g., after requesting and receiving clarification about input parameters from fourth agent 216, and/or can automatedly determine a substitute service to call, effectively replacing first service 224 in the architecture, e.g., if first service 224 does not perform as expected.

Similar principles may apply in third agent 212 determining sixth agent 230, and transmitting a subtask to sixth agent 230 via connection 232, and in third agent 212 determining second service 234 and transmitting an API call to second service 234 via link 236. Second service 234 may reply to third agent via link 238, and, in the event that the reply is an error, third agent 212 may reformulate and resend its API call to second service 234, or may replace second service 234 in the architecture with another available service. For example, if, per the initial user request, it is imperative that an airfare be booked immediately, but second service 234, belonging to a first airline, cannot book the requested airfare due to a technical failure or lack of available seats meeting the user's travel criteria, third agent 212 may, upon receiving an error message via link 238 (or a timeout), select a different service, e.g., from a competing airline, to replace second service 234 in the architecture 200.

There may be an infinite number of ways that an agent may determine to complete a given task or subtask, whether or not different agents may be called to complete different subtasks. In some cases, different ones of these ways may involve calling different agents to complete subtasks, and thus different agentic task architectures being constructed, having different routes within them. In some cases, a given agent may pick one of many possible different ways to complete its assigned task or subtask, each of which may constitute a planning route for the given agent. For example, if an assigned task is to book a vacation, there are many different ways that an agent may approach this task. The agent may go to a travel booking website and may pick a destination at random off a list provided on the travel booking website. The agent may look at a listing of travel options provided on a credit card rewards benefits page. The agent may comb through travel blogs and weather forecasts to make a guess at an appropriate destination. Some task sequences may be more beneficial than others in some respect, e.g., efficiency, computational cost, speed, accuracy, past user satisfaction, likelihood of timely completion, reliability, fairness, loyalty, and so on. Similarly, some agentic architectures may more beneficial than others in some respect. Without guidance, individual agents or agentic task architectures may follow suboptimal paths of data decisions or agentic assignments, or even get lost down “rabbit holes,” proliferating task sequences, subtasks, or new agent assignments in ways that have diminishing likelihood of efficiently accomplishing the originally assigned task, consuming agentic resources to come little nearer the end goal, if nearer at all.

Given that chains, trees, or networks of agents may be called in the formation of an agentic task architecture, the problem of which agent to select to best accomplish a given task or subtask, from the perspective of any given agent, can be broadly considered as a problem of routing. Also, given that different sequences of agentic actions may be performed in completion of a task by a given agent, with numerous choices to be made at any point along the sequence, the sequence planning may also be considered as a problem of routing. An agent in an agentic task architecture, such as agentic task architecture 200, may make one or more selections of agents to assign one or more subtasks to, or may make one or more selections of services to interact with, in accordance with rulesets or guidelines that may be supplied to the agents or services, e.g., as may be provided in a bearer token passed from agent to agent in the architecture. Additionally or alternatively, the agent may make selections of other agents and/or services in accordance with reinforcement learning mechanism trained on data from prior agentic architecture task attempts (failures or completions) and the associated routes, as described in greater detail below.

For example, an agent may access a centralized database or other data store, or a decentralized data store such as a blockchain ledger, to receive agent transition probabilities computed from reward signals. The agent transition probabilities can be based on various forms of feedback, as described in greater detail below, and can effectively guide agents in their intermediary decisions regarding what planning steps to take and/or what other agents or services to enlist to accomplish a task.

Sixth agent 230 may determine a seventh agent 240 and transmit a subtask request to seventh agent 240 via connection 242. In parallel or in sequence with this, sixth agent 230 may determine an eighth agent 244 transmit a subtask request to eighth agent 244 via connection 246. Seventh agent 240 may determine that a conventional service may be accessed to perform a subtask in order to complete the subtask assigned to seventh agent 240 from sixth agent 230, such as a data retrieval or processing task, a transaction task, or a payment task, and accordingly, seventh agent 240 may place an API call to third service 248 via link 250, and receive a response from third service 248 via link 252. The response may be a confirmation or an error message, as examples. Seventh agent 240 may transmit a reply, e.g., indicative of the confirmation or error message, to sixth agent 230 via connection 242. As described above with regard to fifth agent 220 and third agent 212, seventh agent 240 may act autonomously in revising and retransmitting an API call to third service 248 via link 250, and/or in replacing third service 248. Seventh agent may also recognize, prior to transmitting a faulty API call to third service 248, one or more defects in the API call, e.g., due to incomplete, incorrect, or ambiguous data that would be provided as part of the API call, and may proactively resolve the fault, e.g., by communicating up the architecture with sixth agent 230, etc., or by conducting other research or intelligent resolution operations, until complete, correct, and/or unambiguous data is received or determined. This proactivity may save time and/or computing and/or network resources by reducing the number of faulty subtask requests or API calls made to downstream services or agents.

Eighth agent 244, which is an AI agent in the illustrated example of FIG. 2, may interact with a human agent system 254 via connection 256 to complete the performance of a subtask assigned to eighth agent 244 by sixth agent 230. Rather than operating autonomously as an AI agent, the human agent system 254 is controlled by a human agent. For example, human agent system 254 may comprise a personal computer or a telephone. As one example, eighth agent 244 may make a phone call or videoconference call to human agent system 254, announce itself as an artificial intelligence, and explain its directives. Eighth agent 244 may, for example, be configured with text-to-speech and speech-to-text capabilities with which to execute this AI-human interaction functionality. As another example, eighth agent 244 may interact with human agent system 254 via a public or private message board or chat room. As yet another example, eighth agent 244 may compose and send email messages to human agent system 254, and receive emails from human agent system 254 in reply. Accordingly, eighth agent 244, an AI agent, may enlist human aid in accomplishing its assigned subtask. This may happen, for example, in instances in which eighth agent 244 determines that no software service or AI agent is capable of helping it fulfill its subtask, or where eighth agent 244 determines that only a human agent, such as the human agent controlling human agent system 254, is capable of helping eighth agent 244 fulfill its subtask. For example, a human agent controlling human agent system 254 may serve as a gatekeeper to another agentic architecture (not shown) that is a private resource in the control of another party, and that security or privacy concerns, for example, dictate that the private agentic architecture not be accessible by an outside agent, such as eighth agent 244.

Human agent system 254, or another human agent system (not shown), can provide its response via connection 256 or another connection (not shown). For example, a task directive could be initially provided to human agent system 254 by telephone, but a follow-up could be transmitted to eighth agent 244 by email, or vice-versa. Upon completion or failure of its subtask, eighth agent 244 can reply to sixth agent 230 via connection 246. Sixth agent 230 can reply to third agent via connection 232. Third agent 212 can reply to first agent 204 via connection 214. First agent 204 can reply to user system 202 via connection 206.

The agentic task architecture 200 of FIG. 2 is but one example, and other agentic architectures, not illustrated, may be simpler or more complex, having fewer or more agents and/or fewer or more data paths. Some example architectures may involve hundreds, thousands, or millions of agents to complete sophisticated tasks. AI agents may be initiated, provisioned, and terminated as needed and/or when called upon by any individual agent, or may persist to assist a plurality of other individual agents. Accordingly, an agentic task architecture may rapidly grow, shrink, reform, and/or be pruned during the course of a task completion.

Additionally, although the illustrated example shows agents replying only to those individual agents that called them after completing (or failing in completing) a subtask, in other examples, agents may reply to multiple other agents, or to agents other than the individual ones that called them, as may be directed by a calling agent. For example, an initial user request may contain an instruction such as, “If you have any questions, direct them to my spouse, and send any confirmations only to my spouse, not to me,” or such a directive could be inferred by some agent within the agentic task architecture. Accordingly, replies within the agentic architecture would be directed in ways in conformance with this directive. As another example, one AI agent responsible for placing a transaction order from another AI agent could command that any receipts for the order be sent only to yet another agent. Accordingly, replies may be routed along agentic network paths that are not merely in the reverse directions of task assignments in an agentic architecture.

### Problems and Advantages Posed by Agentic Task Architectures and Behaviors

A consequence of agentic architectures like that of FIG. 2 is that performance of tasks and transactions may involve a number of AI agents, digital representations, and systems communicating with one another in ways not experienced in conventional task performances and conventional transactions. As one example, whereas a conventional payment transaction may involve a user swiping or tapping of a physical payment card at a point-of-sale (POS) terminal in a brick-and-mortar business location of a merchant, after which the card issuer and the merchant may be the only parties involved in completing the transaction, an agentic architecture instantiated to complete a transaction may involve multiple parties working with one another to fulfill a transaction request. A user's purchase information and/or payment information may therefore be shared across multiple parties, with the potential that the processes that place sensitive user information into the hands of these parties may be opaque to the user, e.g., during the course of a task or transaction, which may happen very rapidly. For example, in a complex set of global transactions stemming from a single broad task, tens, hundreds or thousands of parties may be involved over the course of seconds.

Accordingly, a user may have no knowledge of, and no ability to meaningfully track in real time, which parties may have obtained the sensitive user data. The parties may be ones with which the user may have had no preexisting relationship or no informed-consented relationship. The various agents involved in a task or transaction may be of various levels of trustworthiness, and/or may be hosted by computing hardware located in various markets (e.g., different countries or other kinds of jurisdictions). Even if initially trusted, some agents may come to be controlled by malicious actors, such as hackers. Some markets (e.g., some countries or other jurisdictions) may have laws or policies that could result in sensitive user information passing through such markets or jurisdictions being turned over to hostile governments or other parties. Still further, as described above, agents may plan task sequences or enlist other agents in ways that are suboptimal in some respect or by some combination of different metrics.

As one example, a calling agent may decide upon a called agent from among a number of possible agents to enlist to perform a task or subtask. From the perspective of the calling agent, the selected called agent may appear to be the best choice, for example, because, as between the available options for the immediate next agent, the called agent may offer the best performance by some metric or combination of metrics. However, because the called agent will, in turn, route data (e.g., make subsequent agentic requests to other agents) along a suboptimal path, a better choice of agent for the calling agent to select may be one of the other, apparently suboptimal agents. Because of its limited perspective of the entire agentic ecosystem and the ways that different other agents may choose to route data through the agentic ecosystem, the calling agent may end up making suboptimal routing decisions in selecting one or more next-layer agents to route data to.

In some examples, lack of intermediate data decision route guidance may cause agents to follow “rabbit holes” that bring them no closer to completing a user-specified task or subtask, or in any case dissatisfactorily closer in proportion to agentic resources expended. In other examples, lack of route guidance may cause agents to place sensitive user data in the hands of untrustworthy agents, services, networks, providers, or markets, potentially exposing the sensitive user data to misuse in fraud, theft, or unwanted intelligence gathering.

System, method, and computer program product embodiments as described herein can serve to address some of the above problems by providing agents in an agentic ecosystem with agent transition probabilities that can guide agents in their selections of actions (e.g., subtasks or routing decisions). Agents can be trained or configured to make selections of actions based on the agent transition probabilities. The agent transition probabilities can be calculated based on total rewards of entire agentic actions paths (e.g., routing paths). Collectively, the agent transition probabilities constitute a reward model that can be shared, in whole or in part, with participating agents (agents that subscribe to the reward model). The reward model can be periodically or continuously updated and redistributed to agents, or, in some examples, generated by individual agents themselves based on data distributed to the individual agents.

When used to improve routing, the provision of the agent transition probabilities can, in effect, give individual agents broader views of the entire agentic ecosystem, ameliorating problems associated with selection of suboptimal or dangerous routing paths and problems associated with “rabbit hole” excursions that follow action paths of no or disproportionately little benefit. Because the reward model can adapt to changes in the agentic ecosystem change thanks to re-training, participating agents can learn to try new routes and/or to avoid “obstacles” placed in the agentic ecosystem, as may happen, for example, when a previously trusted agent becomes compromised, e.g., taken over by hackers, fraudsters, or other hostile parties, and thus becomes something to be avoided.

### Agentic Decision Training Through Reinforced Learning

Decisions taken by agents in an agentic ecosystem can be modeled as an agentic decision tree comprising a plurality of paths. The agentic decision tree can be modeled as a probability network, such as a Markov chain. Nodes in the agentic decision tree can represent states (e.g., agentic decisions) of a finite set of discrete states S, and edges connecting nodes can represent actions, of a finite set of discrete actions A (x) for all x in states S, taken by agents leading to new states. The state at a given time can depend on an action performed, as may be described by a transition function. Transitions may be probabilistic, in that a transition function describing the dependence between a state and a performed action may return a state sampled from a probability distribution over the set of states S. The nodes in an agentic decision tree can represent the different states, as examples, a decision of an agent to carry out a particular task or subtask, or a decision of an agent to enlist another agent to carry out the task or subtask. A policy is a mapping of states to actions, a rule for deciding what action to take given knowledge of the current state. A policy thus specifies what to do in any situation, although not necessarily which specific action to take, since actions may be chosen probabilistically. For example, a policy can specify that an action be independently chosen from a trained probability distribution over the possible actions each time a state is visited. The trained probability distribution can change over time as the system is trained.

A Markov decision process (MDP) is a probabilistic model for reward-incentivized, memoryless, sequential decision-making. An MDP models a scenario in which an agent (the decision maker) iteratively observes the current state, selects an action, observes a consequential probabilistic state transition, and receives a reward according to the outcome. In an MDP, the agent decides each action based on the current state alone and not the full history of past states. An MDP is defined by components including a state space (a set), an action space (a set), a transition probability function that yields a value in the unit interval, and a reward function that yields a value in the unit interval. Monte Carlo tree search (MCTS) is a policy-optimization algorithm for finite-horizon, finite-size MDPs, based on random episode sampling structured by a decision tree. MCTS is incremental in that it can approximate each decision in an optimal policy individually, step by step, and is iterative in that it can use whatever available computation budget to improve its approximation of an optimal decision as much as possible within the constraints imposed by the budget. Examples as described herein can use MDPs and MCTS to implement agentic reinforced learning that can guide agents in improved decision-making, including improved routing.

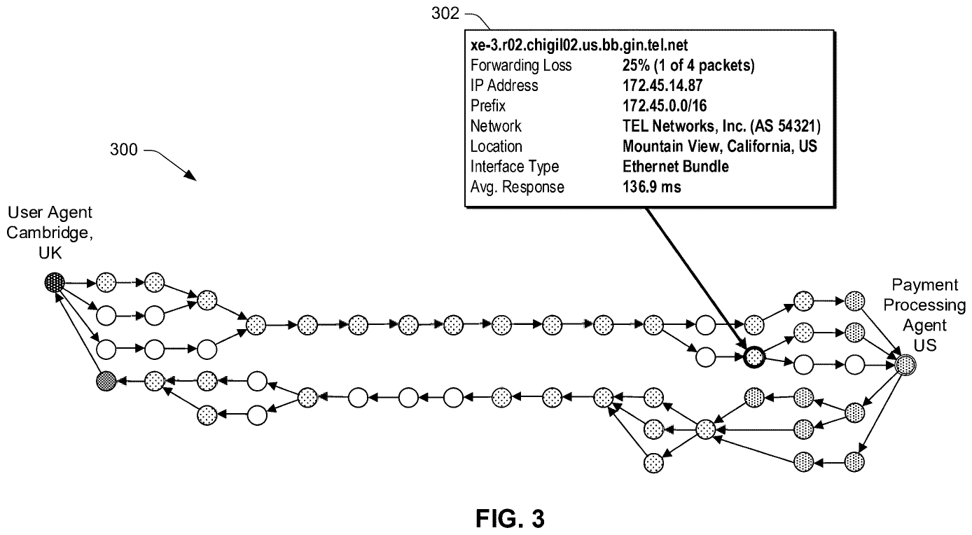

FIG. 3 is a network diagram of an example agentic decision tree 300 having a plurality of nodes connected by edges. The tree 300 FIG. 3 can be understood as showing a plurality of possible decision paths from which only one (or a subset) will be selected. Each fork in the path represents an agentic decision to take a certain action among a plurality of action options, where each action can be, as examples, performing a certain task or subtask, or enlisted a certain other agent with a task or subtask. As shown at 302, any given node in the tree 300 can be localized to a particular agent in an agentic task architecture, having particular properties, such as a given network name, a given IP address, a given network, a given geographical location, a given interface type, a given average response time, a given forwarding loss, etc. Not every node may have unique properties, because some nodes may represent different cognitive decisions by a same agent. Nodes may represent, as examples, different geolocations, different markets (e.g., different countries or other jurisdictions), and/or different providers (e.g., different merchants or different data providers).

In the illustrated example of FIG. 3, a user's agent based in Cambridge, United Kingdom, is given a task (e.g., booking a trip, purchasing an item, etc.) and is faced with multiple action paths, e.g., multiple routes that the agent may choose to send the user's sensitive data (e.g., payment data, preference data, personally identifying information (PII) data, health record data, etc.) through, ultimately arriving at a payment processing agent in the United States. Similarly, the payment processing agent may be faced with multiple action decision paths, e.g., multiple routes of cognitive agents to return a confirmation, digital good, etc. to the user's agent. Requests can be routed through different markets, regions, and networks. For example, payment card information, cryptocurrency, or a purchased or licensed digital good (e.g., a non-fungible token (NFT), a software application, or a media file or stream) may pass from agent to agent along any given route. Certain routes in the agentic decision tree 300 may be preferred, by any of a number of different metrics or combination of metrics, e.g., security, efficiency, likelihood of timely completion, etc. Some routes may be faster. Some routes may be shorter, involving, as examples, fewer other agents, fewer other decisions, or fewer other networks. The entirety of the agentic decision tree 300 may be unknown to individual agents. Agents may nevertheless learn to pick paths of least resistance, or paths of compliant resistance, based on probability values and/or rulesets they are governed by.

A part of an agent's decision-making process may involve, for example, a goal of not disseminating sensitive user data in ways that could unnecessarily expose the sensitive user data. In examples in which another agent is compromised by hackers, sensitive user data obtained by the compromised agent may be shared with the hackers, who may use the information to commit identity theft or fraud, such as misuse of the user's payment information or credit data. The hackers may also configure the compromised agent to alter the information, so that instead of purchasing a ticket for the user's spouse, for example, the ticket is purchased for another party. Accordingly, a decision-making agent may wish to avoid or prohibit transmitting data to a compromised agent, for example, if the compromised agent is known by the decision-making agent to be compromised, or to certain markets or networks, as examples, if the decision-making agent understands that agents in a certain market (or class of markets) or a certain network (or class of networks), as examples, have a greater likelihood of being compromised.

In examples in which an agent that is a selected candidate for use in an agentic task architecture is hosted in a hostile market, or makes use of a hostile network, the government or governing body of the hostile market or hostile network may receive or seize the sensitive user data, and may misuse it for targeting cyberattacks on the user, for example, or otherwise as part of hostile intelligence-gathering operations. The decision-making agent may therefore prefer, prospectively, not to permit hostile-market-hosted agents, or agents that make use of hostile networks, be used for the user's tasks.

When properly controlled, agentic architectures can offer benefits and advantages over other types of architectures and systems that may lack the cognitive intelligence of AI agents. As one example, through reward-model training, agents may learn to preference, de-preference, blacklist, or whitelist certain decision paths, merchants, certain agents, certain markets, or certain networks, as but a few examples. However, given the autonomy of agents enlisted to perform tasks and the limits of understanding of any individual agent of an entire agentic decision tree or agentic task architecture, guiding agents in their decisions can pose difficult technical challenges.

### Training of Agents' Decision-Making Processes Through Reinforced Learning

System, method, and computer program product embodiments as described herein can improve security, efficiency, and likelihood of task completion within complex agentic ecosystems, in which multiple agents interact to fulfill user requests by training agents through reinforced learning. The system, method, and computer program product embodiments described herein can use reinforced training of agents to select decisions, and/or data paths within an agentic task architecture, that allow for, among other things, dynamic routing of user information associated with online transactions. The system, method, and computer program product embodiments described herein can also incorporate an incentivized logging mechanism to promote transparency and collaboration among participants while enabling machine-learning-driven analysis of data flows within agentic task architectures to control and improve use of such architectures. For example, system, method, and computer program product embodiments as described herein can use Q-learning to optimize data paths (routes) of transactions through an agentic payment network.

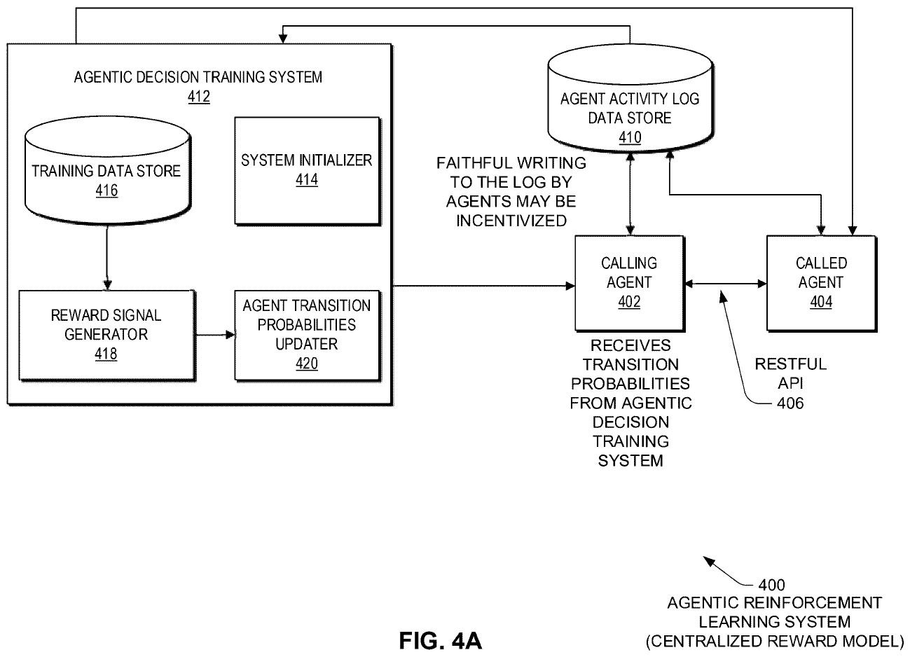

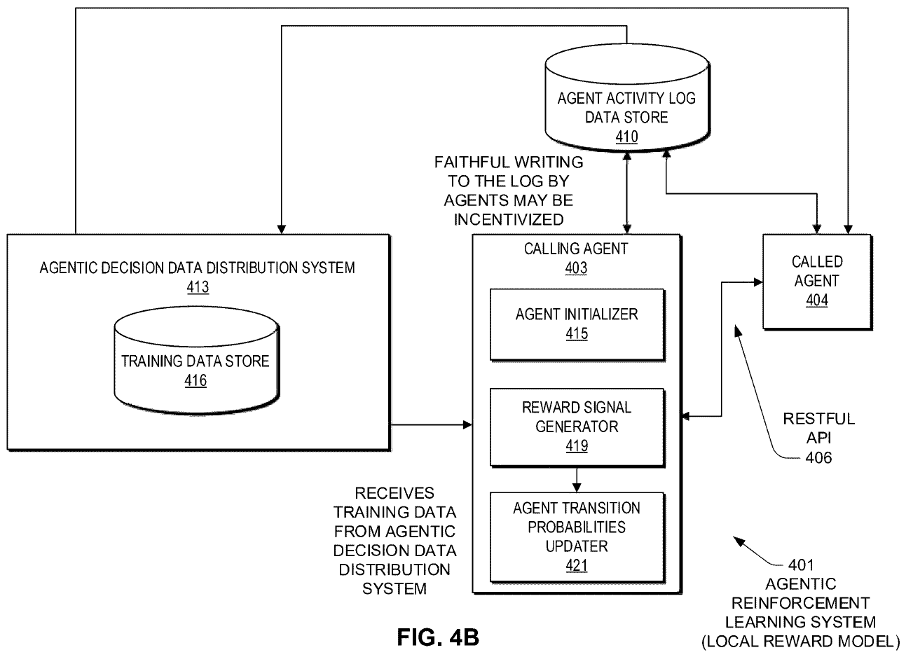

FIG. 4A illustrates an example agentic reinforcement learning system 400, configured to help agents efficiently select provide secure, intelligent routing of data within an agentic ecosystem. Agentic reinforcement learning system 400 includes an agentic decision training system 412, which can be, for example, a centralized system controlled by a single provider, such as a payment card issuer. Agentic reinforcement learning system 400 further includes a number participating agents that subscribe to receive agent transition probabilities from the agentic decision training system 412. In the illustrated example, at least calling agent 402 is a participating agent, configured to participate in the agentic reinforcement learning system 400. Called agent 404, and other agents in the agentic ecosystem, which are omitted from FIG. 4A for simplicity, may also be participating agents.

Secure information exchange between a calling agent 402 and a called agent 404 within an agentic task architecture may take place, for example, using an API that employs representational state transfer (a RESTful API) 406. The RESTful API 406 can, for example, use HTTP requests and responses between agents 402, 404, the requests and responses being sent as REST messages each having a header (or a plurality of headers) and a payload. The RESTful API can accommodate a bearer token, e.g., in an authorization header, that can include authorization credentials containing authentication information of the calling agent 402. The token can further include a hash of the payload that permits verification of authentication and authorization details. The token can further include directives describing who (e.g., which agents) can do what (e.g., can perform what functions with payload data, or can retransmit what payload data). The token can further include other metadata information. The token can further include a cryptographic signature, which can be, for example, a signature of the payload.

Agents of the agentic ecosystem participating in the agentic reinforcement learning system 400 may be unknown to each other or untrusted by one another. For example, calling agent 402 may have no history of interacting with called agent 404 prior to discovering called agent 404, e.g., via a web search or a search a directory of available agents in the agentic ecosystem. Agents participating in the agentic reinforcement learning system 400 can be trained via reinforced learning using, for example, agent activity log data and data derived therefrom (e.g., enriched financial statements showing transactional journeys) as part of training data. So trained, participating agents can be configured, for example, to guide a user's transaction through an agentic ecosystem to ensure that user information passes through specific agentic routes to perform the transaction. The participating agents may be tuned in a number of ways to allow them to autonomously optimize or improve which decisions they make, including which routes sensitive user information is transmitted through. Accordingly, the participating agents may be able to successfully prevent sensitive user information from being passed to network nodes located in hostile markets, for example, or to reduce such instances of improper dissemination of sensitive user information. Use of reinforcement learning system 400 can thereby enhance user trust. Use of reinforcement learning system 400 can also provide a visualization of data journeys for online transactions.

Upon initiation of a task or transaction, trained participating agents, such as calling agent 402, may perform real-time transaction-specific selection of different subtasks to perform or different providers through which the user information is routed. In the illustrated agentic reinforcement learning system 400, this may include selection of called agent 404 by calling agent 402 as a next agent to enlist with a task or subtask. Such enlistment can involve transfer of sensitive user information to called agent 404. Participating agents may be trained by agentic reinforcement learning system 400 to select (e.g., to preferentially select) agents or providers based on any combination of different parameters, such as user preferences, security and privacy goals, or governance regulations. This training can enable path optimization or improvement that can account for factors such as personalization, speed, security, and privacy. Trained participating agents, such as calling agent 402, may dynamically control and modify the routing path of user information on a per-customer and/or per-transaction basis, allowing for a level of control and enhanced security not presently available using existing routing techniques.

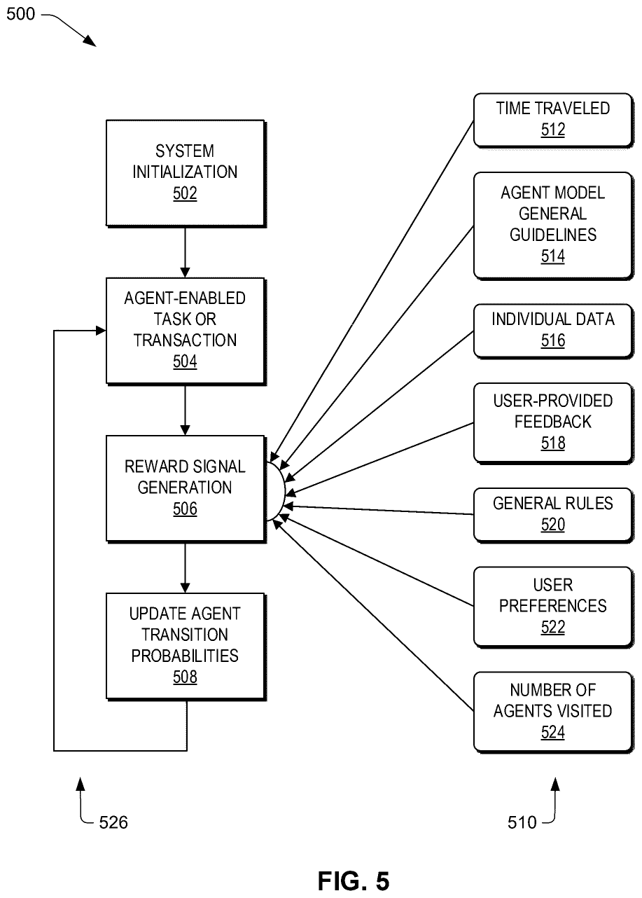

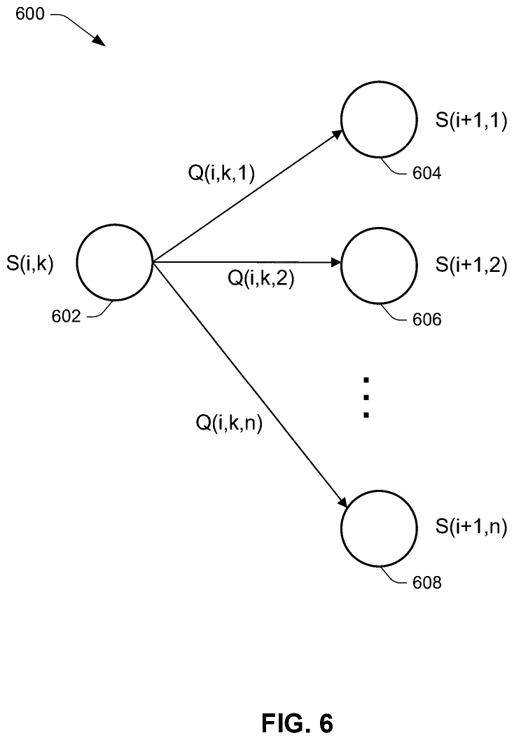

The functioning of the agentic reinforcement learning system 400 in FIG. 4A is described with reference to the flow diagram of FIG. 5. At 502, agentic reinforcement learning system 400 can initialize an agentic system by setting initial transition probabilities of each agent in the agentic system. The initial transition probabilities can be computed by system initializer 414 in FIG. 4A. In assignment of agent transition probabilities, either during system initialization or subsequent updating, an agent transition graph can be modeled as a directed acyclic graph having single start node and single end node selected from among multiple possible end nodes with no loops in the graph. An example directed acyclic graph 600 is illustrated in FIG. 6. Each node in the directed acyclic graph 600 is representative of a state of an agentic system. An agent decision (an action) can be represented as a choice among multiple next-layer nodes in the graph. Each next-layer node can be representative, for example, of a choice of a task or subtask to perform made by the agent of the present layer, or a choice of another agent that the present-layer agent tasks with a task or subtask. Where the action represents a choice of another agent, the action is a routing choice.

In the context of a routing choice, FIG. 6, node 602 in directed acyclic graph 600 can represent the present-layer agent S(i,k) and nodes 604, 606, and 608 in directed acyclic graph 600 can represent three among any number n of possible next-layer agents S(i+1,1), S(i+1,2), S(i+1,n) available for the present-layer agent S(i,k) to route to. In other contexts, the next-layer nodes can represent task or subtask decisions to be made by the present-layer agent S(i,k).

A Q-value function can be computed to yield a quality value (“Q-value”), an expected cumulative reward when following a policy. For the agentic system, the Q-value functions can generally be denoted as Q(i,k,m), where i is the index of an agent of the present layer, i+1 is the index of the next layer, k is an index of a node representative of a present state (e.g., an agent) of the present layer, and m an index of a next-layer node representative of a next-layer state (e.g., an action decision, or a routing decision, e.g., another agent to which a present-layer agent routes). The index m varies from 1 to the number of potential actions n. The probability of a node in the present layer i transitioning to any given node in the next layer i+1 is governed by a probability distribution, with the respective probabilities of transitioning from the node in the present layer to each of the available nodes in the next layer i+1 cumulatively totaling 1.

In system initialization 502, all Q-values can be initialized as an integer plus a floating-point temperature value, e.g., in accordance with Equation 1 as:

$$Q ( i , k , m ) = 1 + τ * rand ( i ) \qquad ( 1 )$$

where τ is a reinforcement learning temperature value, representative of action decision certainty, ranging from 0 to 1, and rand(i) generates a random number from 0 to 1, seeded as i. The τ*rand(i) term in effect randomly perturbs each of the computed Q-values to permit agents some amount of exploration of the agentic ecosystem that can prevent agentic systems from being stuck in habitual behavior. Such habitual behavior could, for example, prevent an agent from discovering new and potentially better routes, e.g., when new or improved agents are introduced to the agentic ecosystem.

A temperature value τ=0 indicates full certainty (no exploration of alternative paths), whereas a temperature value τ=1 indicates no certainty (favored exploration of alternative paths). The temperature t can be set heuristically and can be updated during the training process. As one example, where little training data has been developed, temperature value t can be set initially high to promote exploration of different decision paths, and as training data is developed and the agentic ecosystem is learned, temperature value t can be lowered. As another example, temperature value t can be selected from among a distribution, such as a Gaussian function, and can be initially set to a base approximation (e.g., an average of the Gaussian function), then adjusted periodically as an approximation of an optimum value is progressively improved. In such an example, temperature t distribution may change as the number of potential actions (e.g., the number of agents) changes. Thus, the agentic decision training system can update the temperature value τ distribution (e.g., using a Bayesian approach) regularly or periodically.

Different Q-values can be computed for each present-layer/next-layer node pair. In the illustrated example directed acyclic graph 600 of FIG. 6, present-layer agent S(i,k) at node 602 has a Q-value associated with the action (e.g., the selection of a task, subtask, or agent) S(i+1,1) at next-layer node 604 that is represented by Q(i,k,1); present-layer agent S(i,k) at node 602 has a Q-value associated with the action S(i+1,2) at next-layer node 606 that is represented by Q(i,k,2), and present-layer agent S(i,k) at node 602 has a Q-value associated with the action S(i+1,n) at next-layer node 608 that is represented by Q(i,k,n). At system initialization 502, it may be that the Q-values for each next-layer node are equal. For example, if the next layer i+1 has three only nodes 604, 606, 608, and temperature value τ is set to 0, then the Q-value for each next-layer node will be computed as 1, meaning that there will be an equal ⅓ probability of transition between present-layer agent S(i,k) at node 602 to any of nodes 604, 606, 608. In an agentic routing context, this means that present-layer agent S(i,k) has an equal chance of selecting any of three possible other agents to enlist to perform a task or subtask.

In addition to computing Q-values, also as part of system initialization at 502, agentic reinforcement learning system 400 (e.g., system initializer 414) can compute corresponding initial agent transition probabilities P(i,k,j) in accordance with Equation 2 as follows:

$$P ( i , k , j ) = \frac{{e}^{Q ( i , k , j )}}{{\sum }_{m = 1}^{n} {e}^{Q ( i , k , n )}} \qquad ( 2 )$$

Equation 2 represents but one example probability transition function for computing agent transition probabilities. The example of Equation 2 is a softmax function. In other examples, the exponential function e in Equation 2 can be removed or replaced by a logarithmic function (e.g., log or In) a hyperbolic tangent (tanh) function. Other normalization functions may also be used instead of the one shown in Equation 2. Each computed agent transition probability can be associated with an action, such as a choice of a next agent to make a request of and potentially route sensitive user data to. For example, in a routing context, each agent transition probability can be associated with an HTTP address or API name of an AI agent or online service, or a phone number, or of another kind of communication method or channel.

The agentic decision training system 412 can transmit the initialized agent transition probabilities for corresponding participating agents in the agentic ecosystem (e.g., calling agent 402 and called agent 404). For example, agentic decision training system 412 can transmit (e.g., push) the initialized agent transition probabilities to the corresponding participating agents via an API established for the participating agents, e.g., over a network, such as the internet. The transmission of the agent transition probabilities completes system initialization at 502.

After the system initialization at 502, at 504, in an agent-enabled task or transaction, participating agents in an agentic task architecture make action decisions in accordance with their own machine-learning training and cognitive abilities, in accordance with the initialized agent transition probabilities, and in accordance with any other decision-influencing inputs, e.g., user preferences transmitted from agent to agent along with a bearer token, which may designate certain routes as preferred, un-preferred, or prohibited. The action decision operations of agents can thus generate a path sampled with transition probability as in Equation 2. Consequently, for example, for all possible S(i,k) to S(i+1,m) transitions as shown in the example directed acyclic graph 600 in FIG. 6, only one is selected as part of the transaction path.

Agent actions taken as a consequence of the agent-enabled task or transaction at 504 may be logged to an agent activity log data store 410 of the agentic reinforcement learning system 400. For example, the bearer token, as described above, may specify a network location of a centralized log, or information indicating how logging may be recorded to a decentralized log, such as a distributed ledger or blockchain. The network location can be indicated, for example, by an HTTP address. The information indicating how logging may be recorded to a decentralized log can include, for example, a trusted blockchain address. In either case, centralized or decentralized, the log and its associated logging mechanism are signified in FIG. 4 by agent activity log data store 410. Participating agents, such as calling agent 402 and called agent 404, may choose to record actions via the logging mechanism, contributing to a shared understanding of actions taken and data flow within the agentic task architecture.

Recording of activity to the log by agents may be incentivized to encourage community participation and transparency, providing valuable data for reinforcement learning training. In some examples, agentic decision training system 412 may grant log read access to any agent, or provider of an agent, that faithfully records its agentic activities to the log. Agents and their providers are thus incentivized to write to the log. The agentic decision training system 412 may use trained machine-learning models to search for gaps in the log and thus to identify agents or providers that do not faithfully write to the log, revoking log read access of agents or providers that do not faithfully write to the log. In some examples, agentic decision training system 412 may establish a log read/write currency system, by which a number of faithful writes to the log by an agent or provider entitle a proportional number of reads from the log by the agent or provider. In some examples, agentic decision training system 412 may preference for selection agents that faithfully write to the log, and/or de-preference agents that do not faithfully write to the log, in effect awarding subtask work to faithful logging agents or providers and/or depriving faithless logging agents or providers of subtask work.

Agentic decision training system 412 can gather log data from agent activity log data store 410 after a task or transaction is attempted or completed. This collected log data can be stored, for example, in training data store 416 in agentic decision training system 412. Additionally or alternatively, the log data can be analyzed to produce derivative data, which can include, as examples, visualizations or narratives based on the log data. For example, agentic decision training system 412 or another related system can include a generative machine-learning model (not shown), such as an LLM, trained and configured to process the log data to generate the derivative data, such as the visualizations or narratives. Additionally, agentic decision training system 412 can receive other data related to agentic activities and store it in training data store 416. For example, user-provided feedback 518 can be sent to or collected by agentic decision training system 412 after success or failure of a user-specified task.

At 506, from the log data, the derivative data, and/or the other data, reward signal generator 418 of agentic decision training system 412 can generate a reward signal. As shown in FIG. 5, the reward signal can be generated based on a variety of different feedback data metrics 510, which, in the illustrated example, can include time traveled 512 (e.g., as across an entire agentic task architecture to complete a task), agent model general guidelines 514, individual data 516, user-provided feedback 518, general rules 520, user preferences 522 (as may be specified, for example, in the bearer token), and number of agents visited 524 (e.g., during the entirety of the task completion or attempt). The different feedback data metrics 510 can be derived from the data in the training data store 416, collected as described above. For example, a machine-learning model (not shown) can be trained and configured to derive the feedback data metrics 510 from the data in the training data store 416.

Individual data 516 can, for example, include data used to produce customized signals by a machine-learning model, such as an LLM. User-provided feedback 518 can, for example, be provided as a ternary value for a task or transaction, such as thumbs-up, thumbs-down, or no feedback. General rules 520 can include constraints or steps that must be followed in performing a task or subtask. The general rules 520 can be established for all users of an agent, a provider, or an agentic ecosystem, for example. User preferences 522 can similarly include constraints or steps that must be followed, but established on a per-user basis, e.g., applicable for all tasks or transactions, or only for certain tasks or transactions performed for the user. General rules 520 and user preferences 522 can, for example, include preferred, un-preferred, or prohibited agents, networks, markets, or providers. Number of agents visited 524 can be an important feedback data metric because the likelihood of improper dissemination of sensitive user data increases with the number of parties to which the sensitive user data is distributed, and therefore, use of an excessive number of agents in a task or transaction should be discouraged.

The generated reward signal can, for example, be ternary, having three possible values: positive, negative, or neutral. For example, a positive reward signal is indicative that, considered cumulatively, all actions taken by the agentic task architecture in performance of the agent-enabled task or transaction were positive toward completion of the user-specified task and/or in conformance with other goals, such as preservation of confidentiality of sensitive user data. For example, if a task was successfully completed, user-provided feedback 518 was indicative of satisfaction (or at least not indicative of dissatisfaction), and no general rules 520 or user preferences 522 prohibiting transfer of sensitive user data to malicious or untrusted agents were violated, then reward signal generator 418 may generate a positive feedback signal for the agent-enabled task or transaction.

By contrast, a negative reward signal can, for example, be indicative that, considered cumulatively, all actions taken by the agentic task architecture in performance of the agent-enabled task or transaction were negative toward completion of the user-specified task and/or in conformance with other goals. As one example, if a routing choice made by an agent led to a dead-end, wherein the selected next-layer agent was unable to complete an assigned subtask or further route data, the reward signal can be designated as negative. As another example, if the task caused a super threshold number of agents to be visited 524, or the time traveled 512 exceeded a threshold time, then reward signal generator 418 may generate a negative feedback signal for the agent-enabled task or transaction. As yet another example, feedback indicating that a route improperly exposed sensitive user data and resulted in fraud can cause the reward signal generator 418 to generate a negative feedback signal for the agent-enabled task or transaction.

A neutral reward signal can be indicative that an action taken by an agent was, on balance, neither positive nor negative, when considered cumulative with all actions taken by the agentic task architecture. Reward signal generator 418 can be implemented, for example, as a machine-learning model trained and configured to analyze the feedback data metrics 510 (and/or other metrics, not shown) to generate a reward signal, e.g., a ternary reward signal. Accordingly, reward signals can be generated based on historical data that can be collected, at least in part, from activity logs supplied by individual participating agents in the agentic ecosystem. The goal of the agentic reinforcement learning system 400 is to find sequences of state transitions (e.g., routes through an agentic ecosystem) that maximize the total computed reward by optimizing the transition probability distribution, e.g., from any given agent to the next agent in a route through the agentic ecosystem.

At 508, agent transition probabilities updater 420 can update agent transition probabilities in accordance with the reward signal generated at 506 and a decision tree. The decision tree can, for example, update Q-values for each of the agentic action node connections (as illustrated in FIG. 6) and then update the corresponding transition probabilities accordingly. Listing 1 provides an example decision tree for updating agent transition probabilities.

Listing 1: Example Method for Updating Agent Transition Probabilities

| | |
|---|---|
| 1. | Update the Q function: |
| | if reward_signal = neutral |
| | Do nothing |
| | end |
| | if reward_signal = positive |
| | Q(sel) = Q(sel) + 1 + τ*rand(i) |
| | end |
| | if reward_signal = negative |
| | Q(not sel) = Q(not sel) + 1 + τ*rand(i) |
| | end |
| 2. | Update the transition probability according to Equation 2 (or using another function, |
| | as described above). |

In Listing 1, Q(sel) indicates a Q-value for a possible action selected by a corresponding agent in the course of the agent-enabled task or transaction at 504, and Q(not sel) indicates a Q-value for a possible action not selected by a corresponding agent in the course of the agent-enabled task or transaction at 504.

After the agent transition probabilities are updated at 508 using the newly calculated Q-values and computed in accordance with Equation 2 or another appropriate normalization function, the agentic decision training system 412 may transmit the updated agent transition probabilities to corresponding agents, such as calling agent 402 and called agent 404, in agentic reinforcement learning system 400 of FIG. 4A. The updated agent transition probabilities can, for example, increase the likelihood that agents will select certain actions or make certain routing decisions, and decrease the likelihood that agents will select certain other actions or make certain other routing decisions. For example, agentic routes that dead-end or result in fraud can be penalized, such that it will be less likely that such paths are chosen in the future.

Agentic reinforcement learning system 400 is then ready for a next round of agent-enabled tasks or transactions at 504. Subsequent rounds of tasks or transactions, at 504, reward signal generations, at 506, and agent transition probability updates, at 508, may be iteratively repeated, as indicated by feedback loop 526 in FIG. 5, to progressively train the agentic reinforcement learning system 400. The action selection performance, including the agentic task architecture routing performance, of agentic reinforcement learning system 400, can thus improve with time and use. Agentic reinforcement learning system 400 can still function even if not all of the agents in an agentic ecosystem are participating agents, that is, even if not all of the agents subscribe to and make use of the agent transition probabilities in selecting actions (e.g., routes). Agentic systems can include a mix of participating agents and non-participating agents. Agents hosted by different providers may, in some examples, participate in different separate agentic reinforcement learning systems each functioning substantially like agentic reinforcement learning system 400, each having its own reward model. In some examples, providers or agents may have the option of changing reward model subscriptions to find the reward model that works best for them.

In some examples, agent transition probability functions can be adjusted through hardcoding. For example, if the provider of the agentic reinforcement learning system 400 determines that a certain route (e.g., through a hostile market or network) should never be taken as a matter of policy, the agent transition probability functions can be hardcoded to avoid the blacklisted route absolutely, e.g., with no probability of choosing such a route. In other examples, the probability of choosing a particular action can be hardcoded to be very small, or very large. The transition strategies of subscribing agents can thus be based on these hardcoded agent transition probabilities.

By decentralizing action decisions, including routing decisions, and empowering agents with reinforcement-learning agent transition probabilities and/or self-contained instructions, agentic reinforcement learning system 400 eliminates single points of failure in an agentic architecture, enhances scalability of agentic architecture, and fosters a more collaborative agentic ecosystem from which agentic architectures may be built. The incentivized logging mechanism promotes transparency and continuous improvement of the agentic ecosystem through shared insights. Accordingly, agentic reinforcement learning system 400 enables the development of more intelligent, secure, and adaptable AI agent applications and agentic task architectures capable of handling complex tasks in a trustworthy and collaborative manner.

FIG. 4B illustrates another example agentic reinforcement learning system 401, similar to agentic reinforcement learning system 400 of FIG. 4A, except that initialization at 502, reward signal generation at 504, and agent transition probabilities updating at 508 responsibilities are distributed by being shifted to individual agents, such as calling agent 403, rather than being handled in a centralized manner by agentic decision training system 412. Thus, whereas agentic reinforcement learning system 400 has a centralized reward model, computing the agent transition probabilities in a centralized way and distributing them to participating agents, agentic reinforcement learning system 401 has a local reward model, with each participating agent computing its own agent transition probabilities based on information provided by agentic decision data distribution system 413.

In agentic reinforcement learning system 401, agentic decision data distribution system 413 substitutes for agentic decision training system 412, and each participating agent may be equipped with a respective agent initializer 415, a reward signal generator 419, and an agent transition probabilities updater 421. Agentic decision data distribution system 413 may fulfill some of the functions described above with regard to agentic decision training system 412, such as collection of agent activity log data from agent activity log data store 410, analysis and/or transformation of such data (e.g., to produce visualizations or narratives of such data), and collection of other data, all of which may still be stored in the training data store 416 in FIG. 4B. Rather than computing agent transition probabilities and distributing the computed agent transition probabilities to agents at initialization at 502 and updating at 508, agent initializer 415 in an individual agent (e.g., calling agent 403) may perform the above-described initialization operation for the corresponding agent, reward signal generator 419 may perform the above-described reward signal generation for the corresponding agent, and agent transition probabilities updater 421 may update the agent transition probabilities for the individual agent. Accordingly, these computational tasks are offloaded from a central system (agentic decision training system 412 in agentic reinforcement learning system 400 and agentic decision data distribution system 413 in agentic reinforcement learning system 401) to individual agents.

As another alternative to agentic reinforcement learning system 400 and agentic reinforcement learning system 401, not shown, individual agents may individually perform their own training data collection from agent activity log data store 410. In still other examples, not shown, the agent activity log data store 410 can be incorporated as part of agentic decision training system 412 or agentic decision data distribution system 413. Still other examples, not shown, can be hybrids of agentic reinforcement learning system 400 and agentic reinforcement learning system 401, for example, with a centralized authority such as agentic decision training system 412 providing initialized agent transition probabilities to participating agents, but individual agents performing their own respective updating of their agent transition probabilities.

The described agentic reinforcement learning systems can each operate as fully autonomous feedback loops that can replacement or supplement human-in-the-loop control as may be based entirely on user feedback, with a human user making user preferences changes. Corresponding user preferences can be propagated through an agentic task architecture, for example, via a bearer token passed from agent to agent whenever one agent makes a request of another agent. As one example, user preferences dictating preferred, un-preferred, or prohibited agents, providers, networks, or markets can be given priority, in determining routing, over agent transition probabilities distributed to agents or computed by agents as part of an agentic reinforcement learning system.

### Methods of Agentic Reinforcement Learning

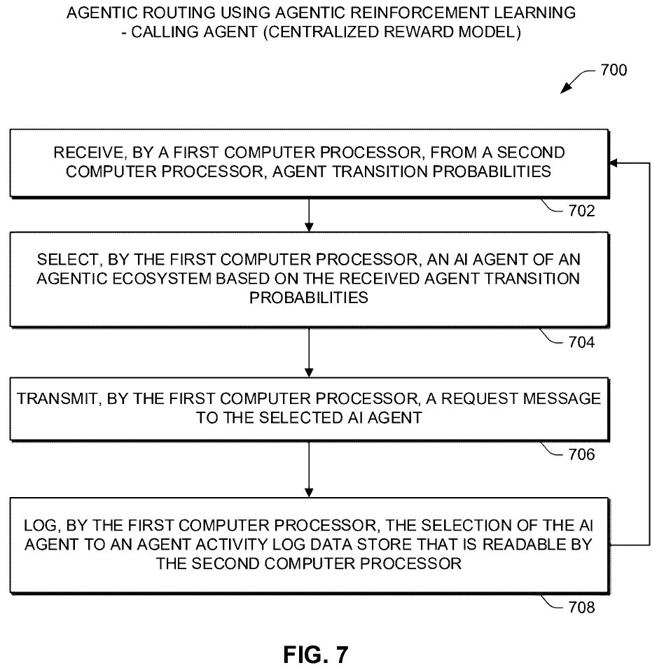

The flow diagram of FIG. 7 illustrates an example computer-implemented method 700 of routing within an agentic ecosystem using agentic reinforcement learning. At 702, agent transition probabilities are received by a first computer processor from a second computer processor. The first computer processor can be, for example, a computer processor executing software code to run an AI agent. The AI agent can be, for example, calling agent 402 in FIG. 4A. The second computer processor can be, for example, a computer processor executing software code to run an agentic decision training system. e.g., agentic decision training system 400 in FIG. 4A. The agent transition probabilities can, for example, be indicative of at least one preferred, un-preferred, or prohibited route of data flow within the agentic ecosystem. The agent transition probabilities can, for example, have been computed (e.g., initialized or updated) by the second computer processor (e.g., by the agentic decision training system 400), as described above.

At 704, the first computer processor selects an AI agent of the agentic ecosystem based on the received agent transition probabilities. As one example, the AI agent hosted by the first computer processor can search the internet or consult a directory for AI agents capable of performing a task (e.g., subtask) that the AI agent hosted by the first computer processor wishes to have performed, and can select from the results of the search or directory consultation one or more suitable AI agents. As another example, the AI agent hosted by the first computer processor may know of suitable AI agents from machine-learning training, and may not need to perform an internet search or consult a directory. Addresses of the suitable AI agents can correspond with (e.g., match) addresses associated with the received agent transition probabilities. The AI agent hosted by the first computer processor can select the selected AI agent of the agentic ecosystem from among the suitable AI agents in accordance with the received agent transition probabilities. For example, if the received agent transition probabilities give a 99 percent probability to selection of a certain AI agent, then there will be a 99 percent chance that the AI agent hosted by the first computer processor will select that certain AI agent as the selected AI agent of the agentic ecosystem, and a 1 percent chance that the AI agent hosted by the first computer processor will select another AI agent from among the suitable AI agents as the selected AI agent of the agentic ecosystem. The selected AI agent of the agentic ecosystem can be, for example, called agent 404 of FIG. 4A.

At 706, the first computer processor can transmit a request message to the selected AI agent of the agentic ecosystem. The request message can include a payload describing a request for the task to be completed by the selected AI agent of the agentic ecosystem. The request message can, in some examples, further include a bearer token containing user preferences, e.g., routing information that can include one or more preferred, un-preferred, or prohibited routes within the agentic ecosystem.

At 708, the first computer processor (e.g., the AI agent hosted on the first computer processor, such as calling agent 402 in FIG. 4A) can log the selection of the AI agent to an agent activity log data store (e.g., agent activity log data store 410 in FIG. 4A) that is readable by the second computer processor (e.g., by agentic decision training system 412 in FIG. 4A). For example, the first computer processor can transmit a logging message to a log. As one example, the first computer processor can send the logging message to an HTTP address of a logger service or a logger AI agent. For example, the HTTP address can be included in the bearer token, or can have been sent to the first computer processor from the second computer processor (e.g., from the agentic decision training system 412 to the calling agent 402). As another example, the logging message is sent to a blockchain address for a distributed log. The blockchain address can similarly be included in the bearer token or sent from the second computer processor to the first computer processor. Logging data in the agent activity log data store can be used by the second computer processor to re-generate agent transition probabilities, as described above with regard to FIGS. 4A, 5, and 6. In some examples, the first computer processor can include in the logging message or in another logging message information about an outcome of the selection of the AI agent. As one example, if the selected AI agent successfully completes a task assigned in the request message, or fails to do so, this can be logged. As another example, the time taken by the AI agent to complete the task, or to return a failure message can be logged. These logging messages can be subsequently analyzed and processed to determine Q-values, to determine policy, and to improve agentic learning.

The re-generated agent transition probabilities can be re-transmitted from the second computer processor to the first computer processor in a repeat of step 702, and steps 704, 706, and 708 can similarly be repeated using the re-generated agent transition probabilities. The method 700 of FIG. 7 thus can represent an iterative loop that can be repeated indefinitely, improving the training of the first computer processor (e.g., of calling agent 402) with each iteration of the loop. Accordingly, method 700 can include repeating the receiving, the selecting, the transmitting, and the logging for a re-generated (e.g., updated) set of agent transition probabilities.

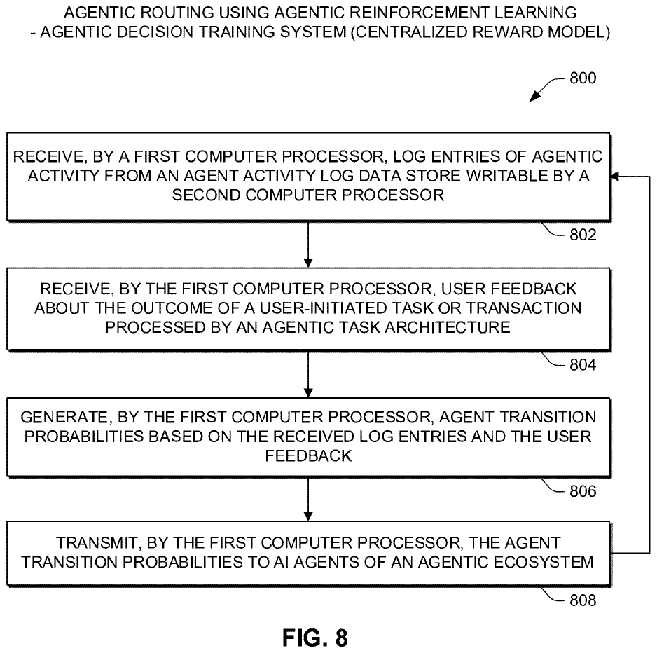

The flow diagram of FIG. 8 illustrates an example computer-implemented method 800 of routing within an agentic ecosystem using agentic reinforcement learning. At 802, a first computer processor receives log entries of agentic activity from an agent activity log data store writable by a second computer processor. The first computer processor can be, for example, a computer processor executing software code to run an agentic decision training system, e.g., agentic decision training system 400 in FIG. 4A. The second computer processor can be, for example, a computer processor executing software code to run an AI agent. The AI agent can be, for example, calling agent 402 in FIG. 4A. The agent activity log data store can be, for example, agent activity log data store 410 in FIG. 4A. The log entries can be, for example, ones written at 708 in method 700 of FIG. 7. For example, the log entries can provide information about actions (e.g., routes) taken within an agentic ecosystem to form agentic task architectures. The log entries can further provide information about the successes or failures of various agentic actions taken during the processing of a user-initiated task or transaction.

At 804, the first computer processor can receive user feedback about the outcome of a user-initiated task or transaction processed by an agentic task architecture. The agentic task architecture can be one formed from agents in the agentic ecosystem. The user feedback can be supplied, e.g., via a user feedback user interface that sends user feedback to the agentic decision training system 412. For example, the user feedback can be indicative that the user-initiated task or transaction succeeded or failed. The user feedback can be in the form of natural language statements (e.g., “I never got the shoes I ordered on December 3” or “My shoe purchase transaction on December 3 leaked my credit card information to fraudsters”) or as discrete responses to feedback form elements, such as checkboxes, radio buttons, and/or dropdown lists, as examples. In some examples, the user feedback can be in the form of ternary values signifying positive, negative, or no feedback, such as thumbs-up/thumbs-down/no response. In some examples, the receipt of user feedback at 804 is omitted from the method.

At 806, the first computer processor can generate agent transition probabilities based on the received log entries and the user feedback. The agent transition probabilities can, for example, be indicative of at least one preferred, un-preferred, or prohibited route of data flow within the agentic ecosystem. The agent transition probabilities can, for example, have been computed (e.g., initialized or updated) by the first computer processor (e.g., by the agentic decision training system 400), as described above. For example, the agent transition probabilities can be those received at 702 in method 700.

At 808, the first computer processor can transmit the generated agent transition probabilities to AI agents of the agentic ecosystem. For example, the first computer processor can transmit the generated agent transition probabilities to the second computer processor, which is configured to execute software code to run an AI agent, e.g., calling agent 402 in FIG. 4A. Different ones of the generated agent transition probabilities can be transmitted to different AI agents of the agentic ecosystem. Each AI agent may have its own respective set of agent transition probabilities. The second computer processor can, for example, be configured to select an AI agent of the agentic ecosystem based on its received agent transition probabilities, as at 704 in method 700. The second computer processor can, for example, be configured to transmit a request message to the selected AI agent of the agentic ecosystem, as at 706 in method 700. The second computer processor can, for example, be configured to log the selection of the AI agent to an agent activity log data store (e.g., agent activity log data store 410 in FIG. 4A) that is readable by the first computer processor (e.g., by agentic decision training system 412 in FIG. 4A). This logging adds new log entries to the agent activity log data store.

The first computer processor can receive the new log entries in a repeat of step 802. The first computer processor can also receive new user feedback in a repeat of step 804. Steps 806 can similarly be repeated to re-generate or update the agent transition probabilities, as described above, as described above with regard to FIGS. 4A, 5, and 6. The re-generated or updated agent transition probabilities can be re-transmitted to the AI agents of the agentic ecosystem, e.g., to the second computer processor referred to at step 802. The method 800 of FIG. 8 thus can represent an iterative loop that can be repeated indefinitely, improving the training of the second computer processor (e.g., of calling agent 402) with each iteration of the loop. Accordingly, method 800 can include repeating the receiving log entries, the receiving user feedback, the generating the agent transition probabilities, and the transmitting the agent transition probabilities for new log entries, new user feedback, and a re-generated set of agent transition probabilities.

Methods 700 and 800 can be interactively performed together by different computer systems within an agentic reinforcement learning system, such as by calling agent 402 and agentic decision training system 412 of agent reinforcement learning system 400 of FIG. 4A. The iterative, interactive performance of the methods 700 and 800 can result in progressive training for routing decisions within an agentic ecosystem and improved routing performance of agents when creating agentic task architectures, as described above.

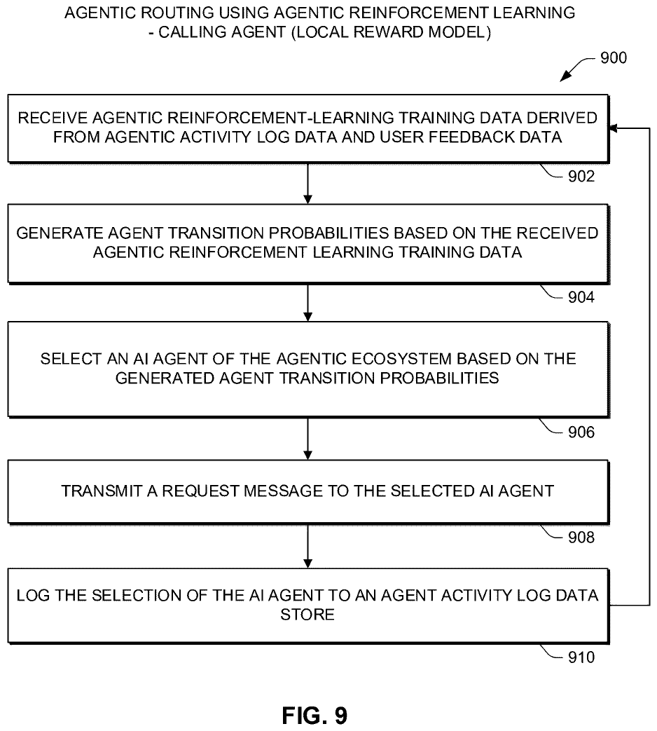

The flow diagram of FIG. 9 illustrates an example computer-implemented method 900 of routing within an agentic ecosystem using agentic reinforcement learning. At 902, agentic reinforcement-learning training data is received by a computer processor. The computer processor can be, for example, a computer processor executing software code to run an AI agent. The AI agent can be, for example, calling agent 403 in FIG. 4B. The agentic reinforcement-learning training data be derived at least in part from agentic activity log data, e.g., as may be provided to an agent activity log data store, such as agent activity log data store 410 in FIG. 4B, from agents within the agentic ecosystem. The agentic reinforcement-learning training data can be received, for example, from an agentic decision data distribution system, such as agentic decision data distribution system 413 in FIG. 4B, which can be configured to collect agent activity log data from the agent activity log data store 410 and user feedback data and to store such data, and/or training data derived therefrom, in a training data store, such as training data store 416 in FIG. 4B.

At 902, the computer processor can generate (or update) agent transition probabilities based on the received agentic reinforcement-learning training data (e.g., based on the log entries and the user feedback). The agent transition probabilities can, for example, be indicative of at least one preferred, un-preferred, or prohibited route of data flow within the agentic ecosystem. The agent transition probabilities can, for example, have been computed (e.g., initialized or updated) by the computer processor (e.g., by calling agent 403 in agentic reinforcement learning system 401), as described above. For example, the agent transition probabilities can be initially generated by agent initializer 415 and subsequently updated by agent transition probabilities updater 421. The agent transition probabilities can be updated as described above with regard to FIG. 5, except that the updating is performed at a local level by the computer processor rather than by an external, centralized system such as agentic decision training system 412 in FIG. 4A, and only agent transition probabilities for the agent (e.g., calling agent 403) are initialized and updated in the method 900. The updating of the agent transition probabilities can be performed after, and based on, computation of one or more reward signals by reward signal generator 419. The reward signals collectively constitute a local reward model.

At 906, the computer processor selects an AI agent of the agentic ecosystem based on the generated agent transition probabilities. As one example, the AI agent hosted by the computer processor can search the internet or consult a directory for AI agents capable of performing a task (e.g., subtask) that the AI agent hosted by the computer processor wishes to have performed, and can select from the results of the search or directory consultation one or more suitable AI agents. As another example, the AI agent hosted by the computer processor may know of suitable AI agents from machine-learning training, and may not need to perform an internet search or consult a directory. Addresses of the suitable AI agents can correspond with (e.g., match) addresses associated with the generated agent transition probabilities. The AI agent hosted by the computer processor can select the selected AI agent of the agentic ecosystem from among the suitable AI agents in accordance with the generated agent transition probabilities. The selected AI agent of the agentic ecosystem can be, for example, called agent 404 of FIG. 4B.

At 908, the computer processor can transmit a request message to the selected AI agent of the agentic ecosystem. The request message can include a payload describing a request for the task to be completed by the selected AI agent of the agentic ecosystem. The request message can, in some examples, further include a bearer token containing user preferences, e.g., routing information that can include one or more preferred, un-preferred, or prohibited routes within the agentic ecosystem.

At 910, the computer processor (e.g., the AI agent hosted on the computer processor, such as calling agent 403 in FIG. 4B) can log the selection of the AI agent to an agent activity log data store (e.g., agent activity log data store 410 in FIG. 4B). For example, the agent activity log data store can be one that is readable by a system that provided the agentic reinforcement-learning training data at 902 (e.g., by agentic decision data distribution system 413 in FIG. 4B). For example, the computer processor can transmit a logging message to a log. As one example, the computer processor can send the logging message to an HTTP address of a logger service or a logger AI agent. For example, the HTTP address can be included in the bearer token, or can have been sent to the computer processor from the system that provided the agentic reinforcement-learning training data at 902 (e.g., from the agentic decision data distribution system 413). As another example, the computer system can send the logging message to a blockchain address for a distributed log. The blockchain address can similarly be included in the bearer token or sent from the system that provided the agentic reinforcement-learning training data at 902 to the computer processor. Logging data in the agent activity log data store can be used by the system that provided the agentic reinforcement-learning training data at 902 to create, update, or supplement the agentic reinforcement-learning training data.

Updated or supplemented agentic reinforcement-learning training data can be re-received by the computer processor in a repeat of step 902, and steps 904, 906, 908, and 910 can similarly be repeated using the updated or supplemented agentic reinforcement-learning training data. The method 900 of FIG. 9 thus can represent an iterative loop that can be repeated indefinitely, improving the training of the computer processor (e.g., of calling agent 403) with each iteration of the loop. Accordingly, method 900 can include repeating the receiving, the generating, the selecting, the transmitting, and the logging for a re-generated (e.g., updated) set of agent transition probabilities.

In the context of FIGS. 7 through 9 and the appended claims, “computer processor” means either a single computer processor or a collection of cooperating processors, which can include, for example, a graphics processing unit (GPU), a tensor processing unit (TPU), or an AI processing unit (AIPU).

When performed by different AI agents within an agentic ecosystem (or corresponding computer processors), method 700 results in routing monitoring and control to build an agentic task architecture that can accomplish any one or more of various objectives of the routing information, such as making the task completion more efficient and thereby saving on processing resources (e.g., processor cycles or memory consumption) or reducing network congestion, or making the task completion more secure by not routing sensitive user information through agents, networks, markets, or providers considered by the user or by another system to be insecure.

The flow diagram of FIG. 8 illustrates an example computer-implemented method 800 of agentic routing monitoring and control, e.g., of routing within an agentic task architecture. At 802, a request message is received, e.g., by an AI agent, e.g., by a computer processor executing software code to run the AI agent. The AI agent can be, for example, called agent 404 in FIG. 4. The request message can include a task and a bearer token including routing information. The bearer token can be, e.g., a JWT that includes the routing information in the claims of the payload of the JWT, as described above. The routing information is indicative of at least one preferred or prohibited route of data flow within an agentic ecosystem. For example, the routing information can have been based on user preference data can have been set by the same or a different AI agent, e.g., that uses an LLM, based on input provided via a user interface, such as a chatbot. As examples, the routing information can include at least one preferred or prohibited agent, market, provider, or network.

At 804, the AI agent or computer processor can verify a cryptographic signature of the bearer token. For example, the AI agent or computer processor can compare a hash of the bearer token with a hash derived from decrypting a signature of the bearer token using a public key of a sender of the request message. If the hashes match, the cryptographic signature can be considered verified, meaning that that bearer token can be trusted as not having been maliciously modified. In some examples, the public key of the bearer token can have been signed by a certificate authority, such as certificate authority 408 in FIG. 4.

At 806, the AI agent or computer processor can analyze the task to determine that the task or a subtask thereof should be performed another AI agent. For example, the AI agent or computer processor can use an LLM or other machine-learning model to analyze the task. The AI agent or computer processor may determine, for example, that the task can be completed by breaking it up into a number of subtasks, one or more of which can be assigned to the other AI agent. As one example, the AI agent or computer processor may recognize that the other AI agent is specialized to be capable of performing the task or subtask, whereas the AI agent or computer processor is not capable of performing the task or subtask. As another example, the AI agent or computer processor may recognize that the other AI agent is has access to a resource, such as a data store or a payment network, required for performing the task or subtask, whereas the AI agent or computer processor does not have access to the required resource. As yet another example, the AI agent or computer processor may recognize that the other AI agent is capable of performing the task or subtask more efficiently, more quickly, or at lower cost than the AI agent or computer processor.

At 808, the AI agent or computer processor can select, as the other AI agent, an AI agent of the agentic ecosystem based on the routing information. For example, the AI agent or computer processor can search the internet or consult a directory for AI agents capable of performing the task or subtask, and can select from the results of the search or directory consultation an AI agent that complies with directives in the routing information as the selected AI agent of the agentic ecosystem.

At 810, the AI agent or computer processor can transmit a request message to the selected AI agent of the agentic ecosystem, the request message including the bearer token, or another bearer token containing the routing information, and a payload describing a request for the task or subtask to be completed by the selected AI agent of the agentic ecosystem.

At 812, the AI agent or computer processor can receive, from the selected AI agent of the agentic ecosystem, a reply message containing a confirmation that the selected AI agent successfully completed the task or an error message describing a reason why the selected AI agent did not successfully complete the task.

Not shown in FIG. 8, the method 800 can further include the AI agent or computer processor transmitting a logging message to a log. As one example, the AI agent or computer processor can send the logging message to an HTTP address of a logger service or a logger AI agent, the HTTP address being included in the bearer token. As another example, the logging message is sent to a blockchain address for a distributed log, the blockchain address being included in the bearer token.

When performed by different AI agents within an agentic ecosystem (or corresponding computer processors), method 800 results in routing monitoring and control to build an agentic task architecture that can accomplish any one or more of various objectives of the routing information, such as making the task completion more efficient and thereby saving on processing resources (e.g., processor cycles or memory consumption) or reducing network congestion, or making the task completion more secure by not routing sensitive user information through agents, networks, markets, or providers considered by the user or by another system to be insecure.

The flow diagram of FIG. 9 illustrates an example computer-implemented method 900 of agentic routing monitoring and control, e.g., of routing within an agentic task architecture. At 902, an AI agent or computer processor can receive log entries of agentic activity associated with a user. For example, the log entries can be representative of the activity of a plurality of agents in an agentic task architecture. For example, the log entries can have been created by agents as described above with regard to FIG. 5. The log entries can be received, for example, from an agentic activity log data store, such as agentic activity log data store 410 in FIG. 4. The AI agent or computer processor can, for example, be part of a payment card issuer system, such as payment card issuer system 412 in FIG. 4.

At 904, the AI agent or computer processor can generate a visualization or narrative using a machine-learning model based on the received log entries. The machine-learning model can be, for example, an LLM, or another generative AI trained to generate visualizations or narratives based on agentic activity log data. The generated visualization or narrative can be rendered to a user interface, e.g., as an intelligent statement.

At 906, the AI agent or computer processor can receive modifications to user preferences as provided to a configuration settings user interface. The modifications to the user preferences can include, for example, at least one preferred or prohibited agent, provider, market, or network. The configuration settings user interface can include, for example, an interaction chatbot user interface, such as the interaction chatbot user interface shown in FIG. 6. The modifications to the user preferences can be, for example, responsive to the generated visualization or narrative, as shown in the example of FIG. 6.

At 908, the AI agent or computer processor can store the received user preference modifications to a user preferences data store, such as user preferences data store 416 shown in FIG. 4.

At 910, the AI agent or computer processor can provide agentic routing information from the user preferences data store to another AI agent. For example, the agentic routing information can include the at least one preferred or prohibited agent, provider, market, or network. The other AI agent can be, for example, an AI agent enlisted to perform a task for the user with whom the agentic activity log entries were received at 902. The other AI agent can, for example, be one trained or otherwise configured to write logs of agentic activity to an agentic activity log data store, such as agentic activity log data store 410 in FIG. 4.

At 912, the AI agent or computer processor can modify a permission setting to allow or deny the other AI agent read access to an agent activity log data store. For example, the agent activity log data store can be one from which the log entries were received at 902 and/or to which the other AI agent is trained or otherwise configured to write logs of agentic activity. For example, the AI agent or computer processor can modify the permission setting based on determining whether or not the other AI agent has faithfully written its agentic activity to the agent activity log data store. For example, the AI agent or computer processor can analyze log entries in the agent activity log data store to determine that gaps in the agent activity log are indicative of failures of the other AI agent to log its agentic activity to the agent activity log data store. For example, the AI agent or computer processor can use a machine learning model trained to analyze the agent activity log to find logging gaps and determine one or more AI agents responsible for the logging gaps.

When performed in the context of an agentic ecosystem, methods 700, 800, and 900 can improve routing of sensitive user information within the agentic ecosystem, resulting in routing that builds an agentic task architecture that can accomplish any one or more of various objectives, such as making the task completion more efficient and thereby saving on processing resources (e.g., processor cycles or memory consumption) or reducing network congestion, or making the task completion more secure by not routing sensitive user information through agents, networks, markets, or providers considered by the user or by another system to be insecure.

### Computing Systems Useful in Agentic Routing Monitoring and Control

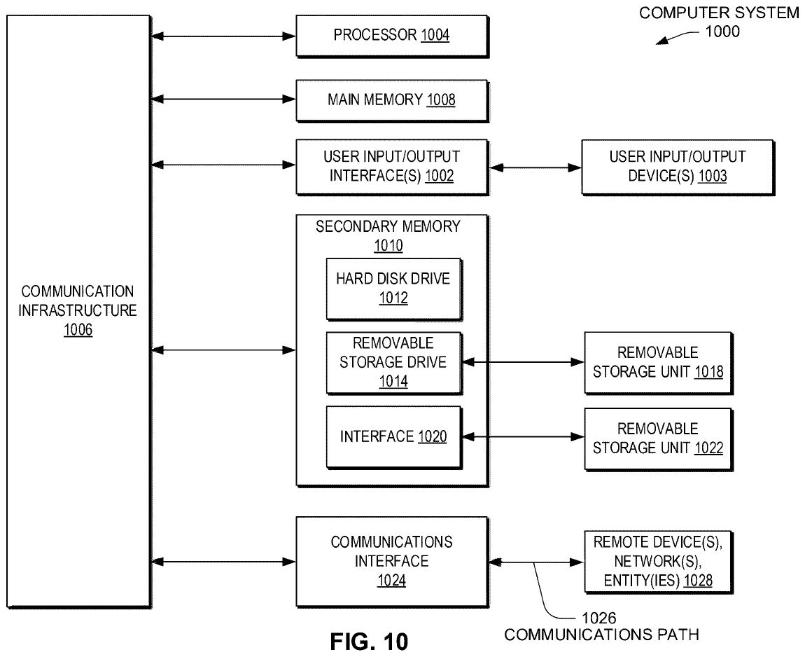

Various embodiments may be implemented, for example, using one or more classical computer systems, such as computer system 1000 shown in FIG. 10. One or more computer systems 1000 may be used, for example, to implement aspects of embodiments discussed herein, as well as combinations and sub-combinations thereof. One or more computer systems 1000 may be used, for example, to implement aspects of agents or services of FIG. 2, 3, 4A or 4A, the agentic decision training system 412 of FIG. 4A, the agentic decision data distribution system 413 of FIG. 4B, the calling agent 402 or called agent 404 of FIG. 4A, the calling agent 403 or called agent 404 of FIG. 4B, the agent activity log data store 410 of FIG. 4A or 4B, or the agentic routing methods 700, 800, or 900 of FIG. 7, 8, or 9. These and other aspects may also be implemented with one or more known quantum computing systems (not shown).

Computer system 1000 may include one or more processors (also called central processing units, or CPUs), such as a processor 1004. Processor 1004 may be connected to a communication infrastructure or bus 1006.

Computer system 1000 may also include user input/output device(s) 1003, such as monitors, keyboards, pointing devices, etc., which may communicate with communication infrastructure 1006 through user input/output interface(s) 1002.

One or more of processors 1004 may be a GPU, TPU, or an AIPU. In an embodiment, a GPU, TPU, or AIPU may be a processor that is a specialized electronic circuit designed to process mathematically intensive applications. The GPU, TPU, or AIPU may have a parallel structure that is efficient for parallel processing of large blocks of data, such as mathematically intensive data common to computer graphics or ML applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the internet of things (IoT), and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premises” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein.

### CONCLUSION

Reinforcement-learning-based agentic decision-making, including routing of user information within networks of AI agents, as described herein, can enable secure, efficient, and collaborative communication within complex agentic ecosystems. By training participating agents to autonomously and probabilistically prefer, de-prefer, or prohibit actions (e.g., agentic routing decisions), the need for centralized routing services that dictate routes can be eliminated and agents can be empowered to make autonomous decisions based on their reinforcement-learning training. Reinforcement-learning-based agentic decision-making not only can enhance agentic system performance and scalability, but can also strengthen security by minimizing potential points of failure and attack vectors. Furthermore, an incentivized agentic activity logging mechanism fosters a transparent and trustworthy environment where participating agents actively contribute to a comprehensive understanding of data flow within an agentic network.

The Detailed Description section, and not any other section, is intended to be used to interpret the claims. Other sections can set forth one or more but not all example embodiments as contemplated by the inventors, and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method of routing within an agentic ecosystem using agentic reinforcement learning, the method comprising:
receiving, by a first computer processor, log entries of agentic activity from an agent activity log data store writable by a second computer processor associated with at least one of a number of artificial intelligence (AI) agents of the agentic ecosystem;
generating, by the first computer processor, agent transition probabilities based on the received log entries, wherein the agent transition probabilities influence probabilistic routing decisions of AI agents of the agentic ecosystem; and
transmitting, by the first computer processor, the agent transition probabilities to a plurality of the AI agents of the agentic ecosystem.

2. The method of claim 1, further comprising:
receiving, by the first computer processor, user feedback about an outcome of a user-initiated task or transaction processed by an agentic task architecture of the agentic ecosystem, the agentic task architecture comprising AI agents of the agentic ecosystem communicatively coupled to process the user-initiated task or transaction,
wherein the agent transition probabilities are generated based on the on the received log entries and the user feedback.

3. The method of claim 1, wherein the generating the agent transition probabilities based on the received log entries comprises:
computing a respective Q-value for each of a plurality next agents of the agentic ecosystem to route to; and
computing a respective agent transition probability, of the agent transition probabilities, for each of a plurality next agents of the agentic ecosystem to route to, based on computing the respective Q-value.

4. The method of claim 3, wherein the computing the respective Q-value comprises updating a corresponding previously computed Q-value by:
adding an integer plus a floating-point temperature value to the previously computed Q-value based on the previously computed Q-value being associated with a selected routing decision and a reward signal associated with the selected routing decision being positive; or
adding the integer plus the floating-point temperature value to the previously computed Q-value based on the previously computed Q-value being associated with a non-selected routing decision and a reward signal associated with the selected routing decision being negative.

5. The method of claim 3, wherein the respective agent transition probability is computed according to a softmax function.

6. The method of claim 1, further comprising:
receiving, by the first computer processor, additional log entries of agentic activity from the agent activity log data store;
generating, by the first computer processor, updated agent transition probabilities based on the received additional log entries; and
transmitting, by the first computer processor, the updated agent transition probabilities to the plurality of the AI agents of the agentic ecosystem.

7. The method of claim 1, wherein the second computer processor is configured to:
receive, from the first computer processor, the agent transition probabilities;
select an AI agent of an agentic ecosystem based on the received agent transition probabilities;
transmit a request message to the selected AI agent; and
log the selection of the AI agent to the agent activity log data store, the agent activity log data store being readable by the first computer processor.

8. An agentic reinforcement-learning training system comprising:
a memory; and
at least one processor coupled to the memory and configured to perform operations comprising:
receiving log entries of agentic activity from an agent activity log data store writable by a computer processor associated with one of a plurality of artificial intelligence (AI) agents of an agentic ecosystem;
generating agent transition probabilities based on the received log entries, the agent transition probabilities influencing probabilistic routing decisions of AI agents of the agentic ecosystem; and
transmitting the agent transition probabilities to a plurality of the AI agents of the agentic ecosystem.

9. The agentic reinforcement-learning training system of claim 8, wherein the operations further comprise:
receiving, by the first computer processor, user feedback about an outcome of a user-initiated task or transaction processed by an agentic task architecture of the agentic ecosystem, the agentic task architecture comprising AI agents of the agentic ecosystem communicatively coupled to process the user-initiated task or transaction,
wherein the agent transition probabilities are generated based on the on the received log entries and the user feedback

10. The agentic reinforcement-learning training system of claim 8, wherein the generating the agent transition probabilities based on the received log entries comprises:
computing a respective Q-value for each of a plurality next agents of the agentic ecosystem to route to; and
computing a respective agent transition probability, of the agent transition probabilities, for each of a plurality next agents of the agentic ecosystem to route to, based on the computing the respective Q-value.

11. The agentic reinforcement-learning training system of claim 10, wherein the computing the respective Q-value comprises updating a corresponding previously computed Q-value by:
adding an integer plus a floating-point temperature value to the previously computed Q-value based on the previously computed Q-value being associated with a selected routing decision and a reward signal associated with the selected routing decision being positive; or
adding the integer plus the floating-point temperature value to the previously computed Q-value based on the previously computed Q-value being associated with a non-selected routing decision and a reward signal associated with the selected routing decision being negative.

12. The agentic reinforcement-learning training system of claim 10, wherein the respective agent transition probability is computed according to a softmax function.

13. The agentic reinforcement-learning training system of claim 8, wherein the operations further comprise:
receiving additional log entries of agentic activity from the agent activity log data store;
generating updated agent transition probabilities based on the received additional log entries; and
transmitting, by the first computer processor, the updated agent transition probabilities to the plurality of the AI agents of the agentic ecosystem.

14. The agentic reinforcement-learning training system of claim 8, wherein the computer processor associated with the one of the plurality of AI agents is configured to:
receive, from the first computer processor, the agent transition probabilities;
select an AI agent of an agentic ecosystem based on the received agent transition probabilities;
transmit a request message to the selected AI agent; and
log the selection of the AI agent to the agent activity log data store, the agent activity log data store being readable by the first computer processor.

15. A non-transitory computer-readable device having instructions stored thereon that, when executed by at least one computing device, cause the at least one computing device to perform operations comprising:
receiving log entries of agentic activity from an agent activity log data store writable by a computer processor associated with one of a plurality of artificial intelligence (AI) agents of an agentic ecosystem;
generating agent transition probabilities based on the received log entries, the agent transition probabilities influencing probabilistic routing decisions of AI agents of the agentic ecosystem; and
transmitting the agent transition probabilities to a plurality of the AI agents of the agentic ecosystem.

16. The non-transitory computer-readable device of claim 15, wherein the operations further comprise:
receiving user feedback about an outcome of a user-initiated task or transaction processed by an agentic task architecture of the agentic ecosystem, the agentic task architecture comprising AI agents of the agentic ecosystem communicatively coupled to process the user-initiated task or transaction,
wherein the agent transition probabilities are generated based on the on the received log entries and the user feedback.

17. The non-transitory computer-readable device of claim 15, wherein the generating the agent transition probabilities based on the received log entries comprises:
computing a respective Q-value for each of a plurality next agents of the agentic ecosystem to route to; and
computing a respective agent transition probability, of the agent transition probabilities, for each of a plurality next agents of the agentic ecosystem to route to, based on the computing the respective Q-value.

18. The non-transitory computer-readable device of claim 17, wherein the computing the respective Q-value comprises updating a corresponding previously computed Q-value by:
adding an integer plus a floating-point temperature value to the previously computed Q-value based on the previously computed Q-value being associated with a selected routing decision and a reward signal associated with the selected routing decision being positive; or
adding the integer plus the floating-point temperature value to the previously computed Q-value based on the previously computed Q-value being associated with a non-selected routing decision and a reward signal associated with the selected routing decision being negative.

19. The non-transitory computer-readable device of claim 15, wherein the operations further comprise:
receiving additional log entries of agentic activity from the agent activity log data store;
generating updated agent transition probabilities based on the received additional log entries; and
transmitting the updated agent transition probabilities to the plurality of the AI agents of the agentic ecosystem.

20. The non-transitory computer-readable device of claim 15, wherein the computer processor associated with the one of the plurality of AI agents is configured to:
receive, from the first computer processor, the agent transition probabilities;
select an AI agent of an agentic ecosystem based on the received agent transition probabilities;
transmit a request message to the selected AI agent; and
log the selection of the AI agent to the agent activity log data store, the agent activity log data store being readable by the first computer processor.
